(19) United States
(12) Patent Application Publication
(10) Pub. No.: US 2024/0075466 A1
(43) Pub. Date: Mar. 7, 2024

(54) One-Pot Synthesis of Transition Metal-Promoted Chabazites

(71) Applicant: Umicore AG & Co. KG, Hanau-Wolfgang (DE)

(72) Inventors: Leen Van Tendeloo, Lier (BE); Frank-Walter Schuetze, Aschaffenburg (DE); Elke Jane June Verheyen, Vosselaar (BE)

(21) Appl. No.: 18/552,714

(22) PCT Filed: Apr. 8, 2022
(86) PCT No.: PCT/EP2022/059425

§ 371 Date: Sep. 27, 2023

(30) Foreign Application Priority Data
Apr. 9, 2021 (EP) 21167633.3

(51) Int. Cl. B01J 29/70; B01D 53/94; B01J 37/04; F01N 3/20

(52) U.S. Cl. CPC B01J 29/7015; B01D 53/9418; B01J 37/04; F01N 3/2066; B01D 2255/50; B01D 2258/01; F01N 2570/14

(57) ABSTRACT

The invention provides methods for a one-pot synthesis of molecular sieves of the CHA-type. The method uses molecular and non-molecular sieves as sources of silicon and aluminum. A first OSDA is selected from tetraethylenepentamine (TEPA) and triethy-lenepentamine (TETA). The synthesis mixture comprises a first metal selected from copper, iron and zinc. Optionally, the synthesis mixture may furthermore comprise a second OSDA and/or a second metal selected from manganese, cesium, magnesium, calcium, strontium, barium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and mixtures thereof. The molecular sieves of the CHA-type obtainable by the method can be used as SCR-catalytically active substances for the removal of nitrogen oxides from exhaust gases of combustion engines.

The present invention relates to a one-pot synthesis method for the preparation of a molecular sieve of the CHA-type as well as to a molecular sieve of the CHA-type obtainable by the respective method. Various uses of the molecular sieve of the CHA-type in catalytic applications are also envisaged.

### Problem to be Solved by the Invention

Zeolites are crystalline microporous aluminosilicate materials formed by corner-sharing TO₄ tetrahedra (T=Si, Al, P, Ge, B, Ti, Sn, etc.) interconnected by oxygen atoms to form pores and cavities of uniform size and shape precisely defined by their crystal structure. Zeolites are also denoted “molecular sieves” because the pores and cavities are of similar size as small molecules. This class of materials has important commercial applications as adsorbents, ion-exchangers and catalysts.

Molecular sieves are classified by the International Zeolite Association (IZA) according to the rules of the IUPAC Commission on Molecular Sieve Nomenclature. Once the topology of a new framework is established, a three letter code is assigned. This code defines the atomic structure of the framework, from which a distinct X-ray diffraction pattern can be described.

It is also common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne) and KFI framework types. Examples having a large pore size are zeolites of the faujasite framework type.

There are a large number of molecular sieve structures known today. Some known molecular sieves belong to certain families of structures with similar features. One specific family, the ABC-6 family, can be described as a stacking of two-dimensional periodic layers of non-connected planar 6-ring motifs, made up from 6 T-atoms (T=Si, Al etc.) connected by oxygen atoms. The resulting layer with hexagonal symmetry is also called the periodic building unit (PerBU). The stacking is typically described by a sequence of letters “A”, “B” and “C” that indicates the relative positions of neighboring layers. “A”, “B” and “C” refers to the well-known relative positions of neighboring layers when stacking hexagonal layers of close packed spheres.

The CHA framework belongs to the ABC-6 family and can be described by a repeating stacking sequence of AABBCC. This leads to a framework topology characterized by a three-dimensional 8-membered-ring pore systems containing double-six-rings (d6R) and cha cages.

Small-pore zeolites, in particular if cations like copper and iron are included in the zeolite pores, play an important role as catalysts in the so-called Selective Catalytic Reduction (SCR) of nitrogen oxides with ammonia to form nitrogen and water. The SCR process has been widely used to clean up exhaust gases which result from the combustion of fossil fuels, in particular from stationary power plants and from vehicles powered by diesel engines.

The catalytic reduction of NOₓ with NH 3 can be represented by different reaction equations. Nitric oxide (NO) is the main NOₓ compound produced in an engine. The reduction of NO is referred to as the “standard” NH₃—SCR reaction:

4NO+4NH₃+O₂→4N₂+6H₂O (1)

NO₂ is more reactive than NO. In presence of mixtures of NO and NO₂, the NH₃—SCR reaction is easier, and the so-called “fast” NH₃—SCR reaction can occur:

2NH₃+NO+NO₂→2N₂+3H₂O (2)

To take profit of the fast NH₃—SCR reaction, an additional catalyst is needed to oxidize part of the NO into NO₂.

Also, side reactions may occur and result in unwanted products or the unproductive consumption of ammonia:

2NH₃+2O₂→N₂O+3H₂O (3)

4NH₃+3O₂→N₂+6H₂O (4)

4NH₃+5O₂→4NO+6H₂O (5)

2NH₃+2NO₂+H₂O→NH₄NO₂+NH₄NO₃ (6)

In official driving cycles, exhaust gas temperatures of latest generation engines and hybrid vehicles with reduced fuel consumption and low CO₂ emission are significantly lower than with previous engine generations. Therefore, it is necessary to obtain a NH₃—SCR catalyst which has a high low-temperature NOₓ conversion capacity. In general, Cu-containing zeolites display a better low-temperature NOₓ conversion then their Fe-containing counterparts.

Next to selectivity and activity, the hydrothermal stability of SCR catalysts is another essential parameter, as an NH₃—SCR catalyst has to withstand harsh temperature conditions under full load of the engine and the exposure to water vapor at temperatures up to 700° C. is known to be critical for many zeolite types.

While zeolites occur in nature, zeolites intended for use as SCR catalyst or other industrial applications are usually manufactured via synthetic processes.

Many processes are described which start from a source of aluminum and a source of silicon and use a structure-directing agent as a template for the structure type to be synthesized.

There is an ongoing search for cheaper Cu-loaded zeolite materials that have an excellent catalytic activity, selectivity and durability in the SCR reaction, to reduce harmful nitrogen oxides using ammonia to form nitrogen gas and water. The cost of Cu-loaded zeolites is largely determined by the raw material cost, the number and throughput of the post-synthesis processing steps, and the liquid waste volumes generated.

One way to reduce the number of processing steps is to already introduce a Cu-source during the hydrothermal synthesis step, a so called ‘one-pot’ synthesis process. Specifically to obtain Cu-chabazite, the Cu-source can be complexed with an amine, such as tetraethylene pentaamine, abbreviated as TEPA, and then the Cu-TEPA complex at the same time functions as the only, and cheap, organic template needed for the synthesis.

However, the Cu amounts (Cu/Al) needed in the gel to form phase pure CHA are high because they require a minimum of 0.5 moles of Cu-TEPA per mole of Al. Furthermore, the methods known so far need Cu-TEPA/Al ratios of at least 0.5 to obtain chabazites with SAR values higher than 6.6. As a consequence these as-made Cu-CHA products have a CuO-content, expressed as Cu/Al or CuO wt %, that is too high to show good selectivity and hydrothermal stability in the SCR reaction. This means that a significant amount of Cu must be removed from the product in post-processing steps. This is time consuming and costly, hard to control due to the risk of not hitting the targeted amount of Cu, and generates high volumes of wastewater contaminated with Cu.

It should be noted that especially in the cost-attractive syntheses in which no FAU is used as an aluminosilicate source, required Cu contents in the state-of-the-art synthesis gels (>0.5 Cu/Al) and products are even higher. Moreover, during the necessary post-syntheses steps to decrease the Cu content, e.g. by using ammonium salts or acids, typically the Na content and the promoter metal content are much lowered concurrently.

WO 2017/080722 A1 and WO 2018/189177 A1 relate to a process for the manufacture of a copper-containing small-pore zeolite which comprises preparing a reaction mixture comprising a faujasite, Cu-TEPA and at least one alkali metal hydroxide. The reaction mixture does not comprise the tetraethylammonium cation. Copper and tetraethylene pentaamine are present in equimolar amounts, i.e. one mole of copper per mole of tetraethylene pentaamine.

CN 101 973 562 A relates to a preparation method for CHA which does not require the use of faujasite or another zeolite as a starting material. The synthesis gel comprises sodium metaaluminate, deionized water, a cupric salt and an organic amine, solid sodium hydroxide and silica. The cupric salt is preferably copper sulfate, and the organic amine is tetraethylene pentaamine. Copper and TEPA are used in equimolar ratios, and at least 2 moles Cu-TEPA per mole of Al₂O₃ are used. The CHA obtained comprises a high amount of CuO, which is reduced in a subsequent step via ion exchange.

CN 104 415 785 A discloses a method for the preparation of a molecular sieve comprising 5 to 30% of ANA and 70 to 95% of CHA. The synthesis gel comprises an alumina source, a silica source, water, sodium hydroxide, a copper source and an organic template. The copper source is preferably copper nitrate or copper sulfate, and TEPA is the preferred organic template. Copper and TEPA are used in equimolar amounts, and at least 2 moles of Cu-TEPA are used per mole of Al₂O₃. This method does not require the use of a molecular sieve, such as FAU, as a starting material. The zeolites obtained comprise 15 to 20 wt.-% CuO.

CN 108 786 900 A relates to a one-pot method for making SSZ-13, which has the CHA framework type. The synthesis gel comprises NaOH, water, an aluminum source, a silicon source, a copper salt, and an organic amine. The copper source is copper sulfate, copper nitrate, or copper chloride, and the organic amine is preferably tetraethylene pentaamine.SSZ-13 seed crystals are required to crystallize the obtained zeolite. The method does not require a zeolite, like, for instance, faujasite, as a starting material. The gel comprises 1.6 to 1.9 moles Cu and 1.5 to 2.2 moles TEPA per mole of Al₂O₃, and the SSZ-13 obtained comprises 15-20 wt.-% CuO.

CN 105 197 955 A discloses a solvent-free method for making SSZ-13. A silicon source, an aluminum source, an alkali source, a copper source and an organic amine are grinded in a mortar and then crystallized for 1 to 10 days at 80 to 120° C. Suitable copper sources are copper sulfate, copper hydroxide and copper acetate. The amine is preferably tetraethylene pentaamine. Copper and the amine are used in equimolar amounts, and the ratio of the Cu-amine complex to Al₂O₃ is about 3 to 4.

CN 108 128 784 A relates to a method of making Cu—Ce-La-SSZ-13. The organic template used in this method is synthesized by first complexing a copper salt with TEPA in an equimolar ratio, followed by the addition of cerium and lanthanum salts. The synthesis gel for the zeolite comprises sodium aluminate, sodium hydroxide, water, silica sol and the Cu—Ce-La-TEPA complex. The gel comprises 1.47 moles Cu and 1.47 moles TEPA per mole of Al₂O₃, and the Cu content of the Cu—Ce-La-SSZ-13 is high.

CN 111 135 860 A refers to a rare earth metal-modified Cu-SSZ-13 and a method of making thereof. The method comprises a one-step synthesis method yielding Cu-SSZ-13 with a silica to alumina ratio of between 6 and 10 and a high copper content. Part of the copper is subsequently removed by liquid ion exchange with an aqueous ammonia salt solution.

CN 109 364 989 A provides a modified Cu-SSZ-13 catalyst and a method for making it. In a first step, Cu-SSZ-13 is subjected to acid leaching, followed by liquid ion exchange with an aqueous ammonia salt solution.

CN 109 985 663 A relates to a post-synthesis method for reducing the Cu content of Cu-SSZ-13. The Cu-promoted zeolite is treated with an alkali solution at a pH value of between 7 and 10. The method avoids the use of ammonium nitrate and strong acid solutions and does not require a heating step.

CN 111 498 865 A discloses a method for making lanthanum-modified Cu-SSZ-13. The Cu-SSZ-13 is synthesized by a one-pot method. The synthesis gel comprises water, sodium aluminate, silica sol, sodium hydroxide and Cu-TEPA. Copper and TEPA are used in equimolar amounts, and the ratio of Cu-TEPA to Al₂O₃ is 2. After the synthesis of Cu-SSZ-13, the copper amount of the as-synthesized zeolite is reduced by liquid ion exchange with an aqueous ammonium nitrate solution. Subsequently, the zeolite is treated with a lanthanum nitrate solution to obtain lanthanum-modified Cu-SSZ-13.

CN 104 386 706 A discloses a method for synthesizing a CHA-type molecular sieve by using a zinc-amine complex as template agent. The synthesis gel comprises sodium aluminate, Zn-TEPA, sodium hydroxide, silica sol, and water. Zn and tetraethylene pentaamine are used in equimolar amounts, and the ratio of Zn-TEPA to Al₂O₃ is 1.5 to 10. After the synthesis, the as-made zeolite is subjected to liquid ion exchange with an aqueous ammonium nitrate solution, and the template agent is removed by calcining.

L Ren, L Zhu, C Yang, Y Chen, Q Sun, H Zhang, C Li, F Nawaz, X Meng and F-S Xiao: “Designed copper-amine complex as an efficient template for one-pot synthesis of Cu-SSZ-13 zeolite with excellent activity for selective catalytic reduction of NOₓ by NH₃”, Chem Commun 2011, 47, 9789-9791 describes a one-pot synthesis of Cu-SSZ-13. The synthesis gel comprises disodium oxide, aluminum oxide, water, silicon dioxide and Cu-TEPA, but it does not require a zeolite, for instance FAU, as a starting material. Copper and TEPA are present in equimolar amounts, and the ratio of Cu-TEPA to Al₂O₃ is 2 to 3. The Cu-SSZ-13 obtained had a copper content of 9.1 to 10.1 wt.-%.

The one-pot synthesis method for making Cu-SSZ-13 described by Ren et al. in Chem Commun 2011, 47, 9789-9791 was also used in Y Shan, J Du, Y Yu, X Shi and H He: “Precise control of post-treatment significantly increases hydrothermal stability of in-situ synthesized Cu zeolites for NH₃—SCR reaction”, Appl Catal B Environ 2020, 266, 118655. The Cu-SSZ-13 zeolites were treated with either diluted HNO3 solution or with NH4NO3 solution at different concentration to remove different amounts of copper in order to adjust the zeolite crystallinity and to optimize the copper species distribution. In R Xu, Z Wang, N Liu, C Dai, J Zhang and B Chen: “Understanding of Zn Functions on Hydrothermal Stability in One-pot Synthesized Cu&Zn-SSZ-13”, ACS Catal 2020, 10, 6197-6212, the method for making Cu-SSZ-13 via a one-pot method as disclosed by Ren et al. in Chem Commun 2011, 47, 9789-9791 was modified in that Cu-TEPA and Zn-TEPA were used as organic structure-directing agents. The SSZ-13 obtained comprised both Cu and Zn and showed an improved hydrothermal stability compared to SSZ-13 comprising Cu alone. The Cu to Al ratio in the product was 0.12, and the Zn to Al ratio was 0.43. The Cu—Zn-SSZ-13 had a SAR value, i.e. a silica-to-alumina ratio, of smaller than 8.

In Z Wu, J Zhang, Z Su, P Wang, T Tan and F-S Xiao: “Low-Temperature Dehydration of Ethanol to Ethylene over Cu-Zeolite Catalysts Synthesized from Cu-Tetraethylenepentamine”, Ind Eng Chem Res 2020, 59, 17300-17306, a one-pot synthesis of Cu-SSZ-13 zeolite is disclosed. The synthesis gel comprises disodium oxide, aluminum oxide, silicon dioxide, water and Cu-TEPA. Copper and TEPA are present in equimolar amounts, and the ratio of Cu-TEPA to Al₂O₃ is 2. The synthesis method does not require a zeolite, for instance FAU, as a starting material. The Cu-SSZ-13 obtained has a copper content of 12.9 wt.-%. The copper content of the as-prepared zeolite can be adjusted by treatment with an aqueous solution of NaNO₃.

In Z Chen, L Guo, H Qu, L Liu, H Xie and Q Zhong: “Controllable positions of Cu2+ to enhance low-temperature SCR activity on novel Cu—Ce-La-SSZ-13 by a simple one-pot method”, Chem Commun 2020, 56, 2360-2363, a one-pot synthesis for making Cu-SSZ-13, Cu—Ce—SSZ-13 and Cu—Ce-La-SSZ-13 is disclosed wherein Cu, Ce and La and complexed with TEPA, and this complex is used as the organic structure-directing agent. The method uses non-zeolitic sources of aluminum and silicon. The ratio of Cu-TEPA to Al₂O₃ in the gel is 1.47, and the obtained zeolite has a high content of CuO.

In L Xie, F Liu, L Ren, X Shi, FS Xiao and H He: “Excellent Performance of One-Pot Synthesized Cu-SSZ-13 Catalyst”, Environ Sci Technol 2014, 48, 566-572, another one-pot method for making Cu-SSZ-13 is disclosed. The synthesis gel comprises Na₂O, Al₂O₃, H₂O, SiO₂ and Cu-TEPA, wherein the amount of Cu-TEPA was reduced to two thirds of the original recipe disclosed in Ren et al., Chem Commun 2011, 47, 9789-9791. However, the as-synthesized zeolite comprised still 10.3 wt.-% of Cu. In a subsequent step, the contents of both sodium and copper were reduced via liquid ion exchange with an aqueous NH₄NO₃ solution.

In Y Yue, B Liu, P Qin, N Lv', T Wan, X Bi, H Zhu, P Yuan, Z Bai, Q Cui and X Bao: “One-pot synthesis of FeCu-SSZ-13 zeolite with superior performance in selective catalytic reduction of NO by NH₃ from natural aluminosilicates”, Chem Eng J 2020, 398, 125515, FeCu-SSZ-13 was synthesized by mixing rectorite, thermally activated diatomite, Cu-TEPA, water and NaOH. Rectorite comprised iron, and it was depolymerized via a submolten salt prior to using it in the one-pot synthesis. The molar ratio of Cu-TEPA to Al2O3 was 3. The FeCu-SSZ-13 zeolite obtained comprised 0.5 wt.-% Fe and 4.8 wt. % Cu.

J Wan, J Chen, R Zhao and R Zhou: “One-pot synthesis of Fe/Cu-SSZ-13 catalyst and its highly efficient performance for the selective catalytic reduction of nitrogen oxide with ammonia”, J Environ Sci 2021, 100, 306-316, discloses a one-pot synthesis for making Fe/Cu-SSZ-13. The synthesis gel comprises water, Cu-TEPA, NaOH, NaAlO₂, K₄[Fe(CN)₆] and silica sol. The ratio of Cu-TEPA to Al₂O₃ is 2.5.

There is a constant need for improved one-pot synthesis methods for the preparation of molecular sieves of the CHA-type which make use of cheap starting materials. Furthermore, it is desirable to synthesize molecular sieves of the CHA-type with a targeted content of copper oxide and alkali metals.

It is therefore an aim of the present invention to provide a one-pot synthesis method for the preparation of a molecular sieve of the CHA-type with targeted contents of copper and alkali metals. Another aim of the present invention is to provide uses of the molecular sieves of the CHA-type in catalytic applications.

### Solution of the Problem

The aim to provide a one-pot synthesis method for the preparation of a molecular sieve of the CHA-type with targeted contents of copper, iron, zinc and mixtures thereof as well as targeted contents of alkali metals is achieved by a method comprising the steps of:
(I) providing the following components:
   (a) a non-molecular sieve source of silicon and/or a non-molecular sieve source of aluminum;
   (b) an alkali metal hydroxide AOH;
   (c) water;
   (d) a first organic structure-directing agent (OSDA1), which is tetraethylenepentamine (TEPA) and/or triethylenetetramine (TETA);
   (e) cations of a first metal Me selected from copper, iron, zinc and mixtures thereof;
   (f) optionally a molecular sieve source of silicon and aluminum; and
   (g) optionally seed crystals of faujasite FAU_{Seed}; and
   (h) optionally at least one salt of one or more second metals P, wherein P is different from the first metal Me; and
   (i) optionally a second organic structure-directing template (OSDA2);
(II) synthesizing and crystallizing a molecular sieve of the CHA-type, comprising the steps of
   aa) mixing first portions of the components a), b) and c) according to step (I);
   ab) optionally adding component g) according to step (I)
   ac) crystallization of the mixture in a reactor;
   ad) adding second portions of the components a), b) and c) and components d) and e) and optionally h) and/or i) to the mixture obtained in step ac);
   ae) crystallization of the mixture obtained in step (II)(ad) in a reactor; or
   ba) mixing components a), b), c), d), e), f) and optionally h) and/or i) according to step (I);
   bb) crystallization of the mixture obtained in step (II)(ba) in a reactor;
   wherein the molar ratios of the components a), b) c), d), e), f) and optionally g), h) and/or i) of step (I) obtained after the completion of steps (II)(ad) and (II)(ba) are as follows:

| | |
|---|---|
| SiO₂/Al₂O₃ | about 10 to about 35 |
| SiO₂/AOH | about 1 to about 2 |
| SiO₂/H₂O | about 0.03 to about 0.2 |
| SiO₂/FAU_{Seed} | about 40 to 400 |
| OSDA1/SiO₂ | about 0.01 to about 0.1 |
| Me/Al | smaller than 0.5 |
| Me/OSDA1 | equal to or smaller than 1.0 |
| P/Me | 0 to 1, |
| OSDA2/OSDA1 | 0 to 0.1; |

and wherein in step (II)(aa) 30 to 75 mol-% of the non-molecular sieve source of silicon, 80 to 100 mol-% of the non-molecular sieve source of aluminum, 40 to 100 mol-% of the alkali metal hydroxide AOH and 30 to 90 mol-% of water are added,
and wherein in step (II)(ad) 70 to 25 mol-% of the non-molecular sieve source of silicon, 20 to 0 mol-% of the non-molecular sieve source of aluminum, 60 to 0 mol-% of the alkali metal hydroxide AOH and 70 to 10 mol-% of water are added,
so that the mixture obtained after the completion of step (II)(ad) contains 100 mol-% each of the non-molecular sieve source of silicon and aluminum, the alkali metal hydroxide AOH and water, and the molar ratios of the components a), b) c), d), e) and optionally g), h) and/or i) of step (I) obtained after the completion of step (II)(ad) are the ones given above;

(III) separating the molecular sieve of the CHA-type.

The novel method for the preparation of a molecular sieve of the CHA-type with targeted contents of copper and alkali metals and the uses of the molecular sieves of the CHA-type in catalytic applications are explained below, with the invention encompassing all the embodiments indicated below, both individually and in combination with one another.

A crystal structure is a description of the ordered arrangement of atoms, ions, or molecules in a crystalline material. Ordered structures occur from the intrinsic nature of the constituent particles to form symmetric patterns that repeat along the principal directions of three-dimensional space in matter. A “crystal” therefore represents a solid material whose constituents are arranged in a crystal structure.

A “crystalline substance” is composed of crystals.

A “zeolite framework type”, also referred to as “framework type”, represents the corner-sharing network of tetrahedrally coordinated atoms.

For instance, a “CHA framework type material” is a zeolitic material having a CHA framework type.

In the method of the present invention a molecular sieve of the CHA-type is prepared. The molecular sieve of the CHA-type can be pure CHA or a molecular sieve which contains CHA as well as other molecule sieves. The amount of the CHA in the molecular sieve containing CHA is typically about 90 to about 100 wt.-%, about 95 to about 100 wt.-%, about 96 to about 100 wt.-%, preferably about 98 to about 100 wt.-%, more preferably about 99 to about 100 wt.-%.

The amount of CHA in the molecular sieve containing CHA is hereinafter referred to as the “phase purity” of the molecular sieve containing CHA. The skilled person knows that the phase purity of a zeolite framework type can be determined via Rietveld analysis of an XRD (X-ray diffraction pattern). The skilled person knows this determination method and can apply it without departing from the scope of the claims.

The other molecular sieve which can be contained is not particularly limited and will depend on the employed reaction conditions. Examples of the other molecular sieve include FAU, MOR, BEA, GME, ANA, LEV, GIS, ERI or mixtures thereof. The other molecular sieve can be present, e.g., as an intergrowth or in admixture with CHA.

In the molecular sieves which are prepared according to the method of the present invention, the amount of molecular sieves other than CHA is up to 4%, more preferably up to 2%, even more up to 1%.

The components to be provided according to step (I) of the method according to the present invent will be explained hereinafter:

The non-molecular sieve source of silicon according to step (I)(a) is not particularly limited as long as it is not a molecular sieve. The non-molecular sieve source of silicon is typically amorphous or the non-molecular sieve source of silicon is provided in the form of a solution or gel. Examples of the non-molecular sieve source of silicon include silica, fumed silica, silicic acid, silicates, colloidal silica, tetraalkyl orthosilicates and mixtures thereof. Preferably the non-molecular sieve source of silicon is a silicate, or an amorphous silica.

The non-molecular sieve source of aluminum according to step (I)(a) is not particularly limited as long as it is not a molecular sieve. The non-molecular sieve source of aluminum is typically amorphous or an aluminum salt. Examples of the non-molecular sieve source of aluminum include alumina, boehmite, aluminum hydroxide, aluminates and mixtures thereof. Examples of the aluminum salt include aluminum nitrate and aluminum sulfate. Preferably the non-molecular sieve source of aluminum is selected from aluminium nitrate, aluminium sulfate, aluminium hydroxide, aluminate or alumina, more preferably amorphous alumina or aluminates.

The non-molecular sieve source of silicon and aluminum according to step (I)(a) is not particularly limited as long as it is not a molecular sieve. Examples of the non-molecular sieve source of silicon and aluminum include precipitated silica-alumina, amorphous silica-alumina, kaolin, amorphous mesoporous materials and mixtures thereof.

The alkali metal hydroxide according to step (I)(b) comprises the alkali metal A as a cation. Alkali metal cations are Li⁺, Na⁺, K⁺, Rb⁺, Cs⁺ and NH₄⁺ and mixtures thereof. The skilled person knows that the size and the charge of the ammonium cation NH₄+ are very similar to that of the potassium cation K⁺, and thus, NH₄⁺ reacts very similar to K⁺ and is therefore summarized under the “alkali metal cations” in the context of the present invention.

In one embodiment of the present invention, the alkali metal hydroxide AOH comprises a mixture of sodium with one or more of the other alkali metal cations listed above. In this embodiment, the molar ratio of sodium cations to the sum of all alkali metal cations is in the range of 1:1 to 1:10, preferably 1:1 to 1:5, more preferably 1:1 to 1:2. In a preferred embodiment, the alkali metal hydroxide cations in the alkali metal hydroxide AOH are a mixture of sodium cations with potassium and/or ammonium cations. In this embodiment, the molar ratio of sodium cations to the sum of (sodium plus potassium plus ammonium cations) is in the range of 1:1 to 1:10, preferably 1:1 to 1:5, more preferably 1:1 to 1:2. In another preferred embodiment, the alkali metal hydroxide AOH is NaOH. The source of NaOH can be sodium hydroxide pellets, an aqueous sodium hydroxide solution and/or sodium silicate Na₂SiO₃, and/or sodium aluminate, or mixtures thereof. Sodium silicate Na₂SiO₃ can be used as a non-molecular sieve source of silicon and aluminum. The skilled person knows that sodium silicate forms alkaline solutions when mixed with water, and by using sodium silicate, NaOH is therefore formed in situ. Sodium aluminate can be used as a non-molecular sieve source of aluminum. Sodium aluminate is a white crystalline solid whose formula can be given as NaAlO₂, NaAl(OH)₄ (hydrated), Na₂O*Al₂O₃, or Na₂Al₂O₄. The skilled person knows that sodium aluminate forms alkaline solutions when mixed with water, and by using sodium aluminate, NaOH is therefore formed in situ.

The first organic structure-directing agent according to step (I)(d), abbreviated as OSDA1, is tetraethylene pentamine TEPA and/or triethylenetetramine (TETA). In a preferred embodiment, the first OSDA is TEPA.

The cations of a first metal Me according to step (I)(e) are selected from cations of copper, iron, zinc and mixtures thereof. Compounds comprising these cations are salts of copper, iron and zinc. Suitable anions of such salts are, for instance, nitrates, sulfates, fluorides, chlorides, bromides, iodides, acetates, oxalates, carbonates and gluconates. The skilled persons knows these salts and their respective solubilities in water. He can apply this knowledge without departing from the scope of the claims. In a preferred embodiment, the cation of a first metal Me is a copper cation.

The component according to step (I)(f) is a molecular sieve source of silicon and aluminum. The molecular sieve source of silicon and aluminum preferably has a silica to alumina ratio of 2 to 8, more preferably 3.5 to 5.5. The molecular sieve can be selected from molecular sieves containing six-ring structural features. Suitable examples of the crystalline molecular sieve containing six-ring structural features include, FAU, LTL, GME, LEV, AEI, LTA, OFF, CHA and ERI and mixtures thereof. Preferably the crystalline molecular sieve containing six-ring structural features is selected from FAU, LTA and mixtures thereof, more preferably FAU. A suitable FAU is Zeolite Y.

The component according to step (I)(g) is seed crystals of faujasite FAU, abbreviated as FAU_{Seed}. In embodiments where FAU_{Seed} is used the molar ratio of SiO₂ sources to FAU_{Seed} is about 40 to about 400, preferably 40 to 100.

The component according to step (I)(h) is at least one salt of one or more second metals P, wherein P is different from the first metal Me. Suitable second metals P manganese, cesium, magnesium, calcium, strontium, barium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and mixtures thereof. In a preferred embodiment, the metal P is selected from Mn, Cs, Mg, Ca, Sr, Ba, Fe, Y, Zr, Ce, Pr, Sm and mixtures thereof; more preferred, P is selected from Mn, Ca, Zr, Fe, Sm, Y and Pr; most preferred, P is selected from Mn, Fe, Sm, Ca, Y, Pr and mixtures thereof. The metals lanthanum, cerium, praseodymium, neodymium, promethium, samarium, europium, gadolinium, terbium, dysprosium, holmium, erbium, thulium, ytterbium, lutetium are hereinafter summarized as “lanthanides” Ln. As mentioned above under step (I)(h), the metal salt P is different from the metal salt Me. This means that if iron and zinc can, independently from one another, be present either as metal Me or as metal P, but not both. It is possible that Me is iron and P is zinc, or that Me is zinc and P is iron, or that Me comprises iron and zinc (with or without copper), or that P comprises iron and zinc. It is, however, not possible, that both Me and P is iron or that both Me and P is zinc.

“At least one salt of one or more second metals P” means that the mixture may contain one or more salts of one lanthanide only, one or more salts of manganese only, cesium only, magnesium only, calcium only, strontium only, barium only, yttrium only, titanium only, zirconium only, niobium only, iron only, zinc only, silver only, or a mixture of one or more salts of at least one lanthanide and at least one salt of manganese, cesium, magnesium, calcium, strontium, barium, yttrium, titanium, zirconium, niobium, iron, zinc, silver, and mixtures thereof. Suitable anions of such salts are, for instance, nitrates, sulfates, fluorides, chlorides, bromides, iodides, acetates, acetylacetonates, oxalates, carbonates and gluconates. The skilled person knows which salts consisting of cations of manganese, cesium, magnesium, calcium, strontium, barium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and the indicated anions exist. Suitable salts consisting of cations of the lanthanides, manganese, cesium, magnesium, calcium, strontium, barium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium and/or lutetium and the indicated anions have a solubility of least 1 g/L of water at a temperature of 25° C.

In a preferred embodiment, the at least one salt of one or more second metals P is selected from salts of Mn, Cs, Mg, Ca, Sr, Ba, Fe, Y, Zr, Ce, Pr, Sm and mixtures thereof; more preferred, it is selected from salts of Mn, Ca, Zr, Fe, Sm, Y and Pr; most preferred, it is selected from salts of Mn, Fe, Sm, Ca, Y, Pr and mixtures thereof

The optional second OSDA according to step MD can be any suitable compound such as a cation having the formula [NR¹R²R³R⁴]⁺, in which R¹, R², R³, and R⁴ are independently alkyl groups with one to four carbon atoms. The alkyl group can be optionally substituted by one or more hydroxy groups. In a preferred embodiment, all four of the R-groups are alkyl groups having one to four carbon atoms and at least two of the alkyl groups have two to four carbon atoms. The alkyl groups are preferably linear but branched alkyl groups can also be employed. Examples of alkyl groups with one to four carbon atoms include methyl, ethyl, n-propyl, iso-propyl, n-butyl, iso-butyl, sec-butyl or tert-butyl. Preferred are methyl, ethyl, n-propyl, and n-butyl. Examples of possible second OSDAs include tetraethylammonium, methyltriethylammonium, propyltriethylammonium, diethyldipropylammonium, diethyldimethylammonium, trimethylethylammonium, trimethylpropylammonium, a choline cation and mixtures thereof. Preferably the second OSDA is tetraethylammonium, diethyldimethylammonium, methyltriethylammonium or propyltriethylammonium, more preferably tetraethylammonium or methyltriethylammonium. In one embodiment, the OSDA is tetraethylammonium. In another embodiment, the OSDA is methyltriethylammonium.

The second organic structure-directing agent can furthermore be elected from dimethylethylcyclohexylammonium, 1,4,8,11-tetraazacyclotetradecane, 1,4,8,11-tetramethyl-1,4,8,11-tetraazacyclotetradecane, and it can be trimethyladamantylammonium or trimethylbenzylammonium.

The anion of the second OSDA is not particularly limited as long as it does not interfere with the formation of the molecular sieve. Examples of typical anions include, but are not limited to, hydroxide, chloride, bromide, and iodide and mixtures thereof, more typically hydroxide.

In one embodiment of the present invention, only an OSDA1 is provided, which is TEPA and/or TETA, more preferably TEPA.

The term “optionally” used for components (f) to (i) of step (I) means that these components are present in some, but not in all embodiments of the present invention. By contrast, the components (a) to (e) according to step (I) are present in all embodiments. The embodiments will be explained in more detail hereinafter.

In step (II) of the method according to the present invention, synthesizing and crystallizing a molecular sieve of the CHA-type is carried out.

A mixture containing all components that are necessary for synthesizing the desired zeolite is called a “synthesis gel” or just a “gel”. In the present invention, the “synthesis gel” corresponds to the mixtures obtained after step (II)(ad) or step (II)(ba), respectively. The composition of the synthesis gel for all embodiments of the present invention is given below.

In one embodiment, steps (II)(aa) to (II)(ae) are carried out. In this embodiment, non-molecular sieve sources of silicon and aluminum are used, and optionally seed crystals of FAU, also called FAU seed, are added, but no molecular sieve source of silicon and aluminum as listed under step (I)(f) is used.

In step (II)(aa), first portions of the components (a), (b) and (c) according to step (I) are mixed. This means that a non-molecular sieve source of silicon and/or a non-molecular sieve source of aluminum, an alkali metal hydroxide and water are mixed.

The non-molecular sieve source of silicon and/or aluminum can be
a mixture of a non-molecular sieve source of silicon (Siₙₒₙ₋ₘₛ) and a non-molecular sieve source of aluminum (Al_{,non-ms}); or
a non-molecular sieve source of silicon and aluminum (Siₙₒₙ₋ₘₛ+Alₙₒₙ₋ₘₛ); or
a mixture of a non-molecular sieve source of silicon and aluminum (Siₙₒₙ₋ₘₛ+Alₙₒₙ₋ₘₛ) and a non-molecular sieve source of silicon (Siₙₒₙ₋ₘₛ); or
a mixture of a non-molecular sieve source of silicon and aluminum (Siₙₒₙ₋ₘₛ+Alₙₒₙ₋ₘₛ) and a non-molecular sieve source of aluminum (Alₙₒₙ₋ₘₛ); or
a mixture of a non-molecular sieve source of silicon and aluminum (Siₙₒₙ₋ₘₛ+Alₙₒₙ₋ₘₛ), a non-molecular sieve source of silicon (Siₙₒₙ₋ₘₛ) and a non-molecular sieve source of aluminum (Alₙₒₙ₋ₘₛ);
wherein
Siₙₒₙ₋ₘₛ=non-molecular sieve source of silicon which does not comprise Al
Alₙₒₙ₋ₘₛ=non-molecular sieve source of aluminum which does not comprise Si
(Siₙₒₙ₋ₘₛ+Alₙₒₙₘₛ)=non-molecular sieve source which comprises both silicon and aluminum.

“First portions” means that only a part, but not the full amount of components a), b) and c) that will be present in the synthesis gel according to step (II)(ad) will be used in step (II)(aa). In step (II)(aa) 30 to 75 mol-% of the non-molecular sieve source of silicon, 80 to 100 mol-% of the non-molecular sieve source of aluminum, 40 to 100 mol-% of the alkali metal hydroxide AOH and 30 to 90 mol-% of water are used. Optionally, seed crystals of faujasite FAU seed are also added to this mixture in step (II)(ab). It is obvious that FAU is a molecular sieve comprising silicon and aluminum. In this embodiment, wherein seed crystals of FAU are used, the molar ratio of SiO₂ sources to FAU_{Seed} is about 40 to about 400, preferably larger than or equal to 40 to 100.

Subsequently, the mixture consisting of portions of components a), b) and c) and optionally also containing component g) is crystallized for 1 to 24 hours at 20 to 110° C. in a reactor. The reaction mixture can be subjected to stirring during the crystallization. The skilled person knows that the lower the crystallization temperature, the longer the crystallization time must be. He can apply this knowledge without departing from the scope of the claims. Chemical reactors are enclosed volumes in which chemical reactions take place, for instance beakers, vessels, batch reactors and autoclaves. Reactors are known to the skilled person and can be applied without departing from the scope of the claims.

After the crystallization according to step (II)(ac) has been carried out, second portions of the components a), b) and c) are added to the mixture. The non-molecular sieve source of silicon and/or aluminum can be the same as given above. In a preferred embodiment, the non-molecular sieve source of silicion and/or aluminum added in step (II)(ac) is selected from
a non-molecular sieve source of silicon and aluminum (Siₙₒₙ₋ₘₛ+Alₙₒₙ₋ₘₛ); or
a mixture of a non-molecular sieve source of silicon and aluminum (Siₙₒₙ₋ₘₛ+Alₙₒₙ₋ₘₛ) and a non-molecular sieve source of silicon (Siₙₒₙ₋ₘₛ); or
a non-molecular sieve source of silicon (Siₙₒₙ₋ₘₛ).

Furthermore, the components d), e) and optionally h) and/or i) are added. “Second portions of the components a), b) and c) means that 70 to 25 mol-% of the non-molecular sieve source of silicon, 20 to 0 mol-% of the non-molecular sieve source of aluminum, 60 to 0 mol-% of the alkali metal hydroxide AOH and 70 to 10 mol-% of water are added, so that the mixture obtained after the completion of step (II)(ad) contains 100 mol-% each of the non-molecular sieve source of silicon and aluminum, the alkali metal hydroxide AOH and water. Furthermore, components d) and e) and optionally h) and/or i) are added. The mixture obtained after the completion of step (II)(ac) is the synthesis gel of this embodiment. The composition of the synthesis gel with respect to the molar ratios of the individual components is given below.

In step (II)(ae), the synthesis gel obtained after the completion of step (II)(ad) is crystallized for 10 to 50 hours at 95 to 160° C. In one embodiment, the crystallization is carried out by heating the mixture for 24 to 100 hours at 120 to 160° C. In another embodiment, the crystallization is carried out for 18 to 22 days at 90 to 100° C. The reaction mixture can be subjected to stirring during the crystallization.

As mentioned above, the skilled person knows that the lower the crystallization temperature, the longer the crystallization time must be. Thus, this step includes crystallization times of 10, 15, 20, 25, 30, 35, 40, 45 and 50 hours at temperatures of 95, 100, 105, 110, 115, 120, 125, 130, 135, 140, 145, 150, 155 and 160° C., and the skilled person can apply this knowledge to determine suitable combinations of times and temperatures of crystallization without departing from the scope of the claims. The amount of the zeolite which has been formed under the chosen crystallization conditions can, for example, be measured by XRD, and the skilled person can thus easily adjust times and temperatures to obtain the optimum yield of the desired zeolite.

In another embodiment, steps (II)(ba) and (II)(bb) are carried out. In step (II)(ba) of this embodiment, components a), b), c), d), e) and f) and optionally h) and/or i) are mixed. Component a), which is the non-molecular sieve source of silicon and/or aluminum, can be
a mixture of a non-molecular sieve source of silicon (Siₙₒₙ₋ₘₛ) and a non-molecular sieve source of aluminum (Al_{,non-ms}); or
a non-molecular sieve source of silicon and aluminum (Siₙₒₙ₋ₘₛ+Alₙₒₙ₋ₘₛ); or
a mixture of a non-molecular sieve source of silicon and aluminum (Siₙₒₙ₋ₘₛ+Alₙₒₙ₋ₘₛ) and a non-molecular sieve source of silicon (Siₙₒₙ₋ₘₛ); or
a mixture of a non-molecular sieve source of silicon and aluminum (Siₙₒₙ₋ₘₛ+Alₙₒₙ₋ₘₛ) and a non-molecular sieve source of aluminum (Alₙₒₙ₋ₘₛ); or
a mixture of a non-molecular sieve source of silicon and aluminum (Siₙₒₙ₋ₘₛ+Alₙₒₙ₋ₘₛ), a non-molecular sieve source of silicon (Siₙₒₙ₋ₘₛ) and a non-molecular sieve source of aluminum (Alₙₒₙ₋ₘₛ);
   with the definitions of the abbreviations as given above.

In this embodiment, the molar ratio of SiO₂ of the non-molecular sieve source of silicon to the molecular sieve source of silicon is smaller than 40, preferably smaller than 20, more preferably smaller than 10.

In step (II)(ba), the synthesis gel obtained after the completion of step (II)(ba) is crystallized for 10 to 50 hours at 95 to 160° C. As mentioned above, the skilled person knows that the lower the crystallization temperature, the longer the crystallization time must be. Thus, this step includes crystallization times of 10, 15, 20, 25, 30, 35, 40, 45 and 50 hours and temperatures of 95, 100, 105, 110, 115, 120, 125, 130, 135, 140, 145, 150, 155 and 160° C., and the skilled person can apply this knowledge to determine suitable combinations of times and temperatures of crystallization without departing from the scope of the claims. The amount of the zeolite which has been formed under the chosen crystallization conditions can be measured, for example, by XRD, and the skilled person can thus easily adjust times and temperatures to obtain the optimum yield of the desired zeolite.

The molar ratios of the components a), b) c), d), e), f) and optionally g), h) and/or i) of step (I) obtained after the completion of steps (II)(ad) and (II)(ba) are as follows:

| | |
|---|---|
| SiO₂/Al₂O₃ | about 10 to about 35, preferably about 10 to about 25; |
| SiO₂/AOH | about 1 to about 2, preferably about 1.3 to about 1.7; |
| SiO₂/H₂O | about 0.03 to about 0.2, preferably |
| | about 0.04 to about 0.09; |
| SiO₂/FAU_{Seed} | about 40 to 400 |
| OSDA1/SiO₂ | about 0.01 to about 0.1, preferably |
| | 0.012 to about 0.06; |
| Me/Al | smaller than 0.5, preferably 0.1 to 0.4; |
| Me/OSDA1 | equal to or smaller than 1.0, preferably 0.4 to 0.8; |
| P/Me | 0 to 1, preferably 0.25 to 0.60; |
| OSDA2/OSDA1 | 0 to 0.1. |

As mentioned above, the completion of steps (II)(ad) and (II)(ba) yields the synthesis gel of the respective embodiment. As can be seen from the list above, the molar ratios of the components a), b), c), d), and e), which are present in both embodiments, are the same. In case of the first embodiment of step (II), corresponding to steps (aa) to (ae), only non-molecular sieve sources of silicon and aluminum are used, and seed crystals FAU seed are added. In case of the second embodiment of step (II), corresponding to steps (ba) to (bb), non-molecular and molecular sieve sources of silicon and aluminum, but no seed crystals FAU seed are used. However, in both embodiments, the silica-to-alumina ratio, the silica-to-water ratio and the silica-to-alkali metal hydroxide, the ratio of M to aluminum and the ratio of OSDA1 to silica are the same. The same applies for the ratios of the optional components P and OSDA2. Irrespective of the embodiments according to steps (II)(aa) to (ae) or (II)(ba) to (bb), the ratios of P to Me and of OSDA1 to OSDA2 in the synthesis gel are the same in case P and/or the OSDA2 are present.

Once the crystallization has been completed the resulting solid molecular sieve product is separated from the remaining liquid reaction mixture according to step (III) by conventional separation techniques such as decantation, (vacuum-)filtration or centrifugation. The recovered solids are then typically rinsed with water and dried using conventional methods (e.g. heating to about 75° C. to 150° C., vacuum drying or freeze-drying etc.) to obtain the ‘as-synthesized’ molecular sieve.

The “as-synthesized” or “as made” product or zeolite refers to the molecular sieve after crystallization and prior to NH₄⁺ exchange and removal of the OSDAs or other organic additives.

The organic molecules still retained in the as-synthesized molecular sieve are in most cases, unless used in the as-synthesized form, removed by thermal treatment in the presence of oxygen. The temperature of the thermal treatment should be sufficient to remove the organic molecules either by calcination, evaporation, decomposition, combustion or a combination thereof. Typically, a temperature from about 150 to about 750° C. for a period of time sufficient to remove the organic molecule(s) is applied. A person skilled in the art will readily be able to determine a minimum temperature and time for this heat treatment. Other methods to remove the organic material(s) retained in the as-synthesized molecular sieve include extraction, vacuum-calcination, photolysis or ozone-treatment.

In embodiments of the present invention, it is desirable to remove a part or all of the alkali ions (e.g. Na⁺) and/or the part of the transition metal from the molecular sieve, e.g., by ion-exchange or other known methods. Desired metal ions may also be included in the ion-exchange procedure or carried out separately. Ammonium exchange can be carried out by treating the as-synthesized zeolite with an aqueous solution comprising ammonium salts, for instance by treatment with an aqueous ammonium nitrate solution. The ammonium ions replace part or all of the alkali ions and/or part of the transition metal. Drying the zeolite at 50 to 120° C. yields the “ammonium form” or of the zeolite. The ammonium form of the zeolite can also be converted into the proton form by calcining at temperatures of 450 to 750° C. Ion exchange in general, the treatment of zeolites with aqueous ammonium salt solutions and the conversion of ammonium-exchanged into the corresponding proton forms are known to the skilled person. These methods can be applied without departing from the scope of the claims.

In one embodiment of the present invention, the at least one metal P is not introduced into the molecular sieve of the CHA type during the one-pot synthesis, but afterwards via ion exchange. This means that no component h) as described above is used during the synthesis. By contrast, the at least one metal P is introduced after the separation of the molecular sieve of the CHA type according to step (III) of the method according to the present invention.

Manganese, for instance, can be introduced via ion exchange. In a first step, an ammonium exchange is performed in order to remove alkali or alkaline earth metal cations from the zeolite framework by replacing them with NH₄⁺ cations. In a second step, NH₄⁺ is replaced by manganese cations. The manganese content of the resulting manganese-containing zeolite can be easily controlled via the amount of manganese salt and the number of ion exchange procedures performed. The manganese content can be measured by ICP-AES or XRF as mentioned above.

Manganese and other cations of a metal P can also be removed by liquid ion exchange with NH₄⁺ cations.

Methods for introducing ammonium, manganese and other cations of a metal P for removing cations of copper, a metal P as listed above and alkali metal cations are well known to the skilled artisan. They can be applied to the zeolites according to the present invention without departing from the scope of the claims. For example, ammonium cations can be easily introduced via liquid ion exchange, and manganese cations can also easily be introduced via liquid ion exchange, incipient wetness impregnation or solid state ion exchange.

Said methods for introducing or removing cations are presented exemplarily hereinafter for the introduction of cations of the metal P, for example cations of manganese. These methods are applicable to obtain zeolites according to the present invention which are loaded with copper and a least one metal P.

Liquid Ion Exchange

An NH₄⁺ liquid ion exchange can be performed by treating the zeolite with an aqueous solution of an ammonium salt, for example NH₄Cl or NH₄NO₃.

A Mn²⁺ liquid ion exchange can be performed by treating the zeolite with an aqueous solution of a manganese salt, manganese(II) acetate (Mn(CH₃COO)₂), manganese(II) acetylacetonate (Mn(acac)₂), manganese(III) acetylacetonate (Mn(acac)₃), manganese(II) chloride (MnCl₂), manganese(II) sulfate (MnSO₄) and manganese(II) nitrate (Mn(NO₃)₂). This procedure can be repeated multiple times in order to achieve the desired manganese content.

It is obvious for the skilled person that the manganese to zeolite ratio in liquid ion exchange can be adjusted according to the desired manganese content of the final zeolite. Generally spoken, aqueous solutions with higher manganese contents yield higher manganese-containing zeolites. Which manganese concentration should be chosen and how often the procedure shall be repeated can easily be determined by the skilled person without departing from the scope of the claims.

Optionally, the ammonium-exchanged zeolite can be subjected to heat treatment in order to partially or completely remove the ammonium ions as indicated above. Subsequently, the manganese exchange can be carried out as described above.

Incipient Wetness Impregnation

An aqueous solution of a manganese salt, for example manganese(II) acetate (Mn(CH₃COO)₂), manganese(II) acetylacetonate (Mn(acac)₂), manganese(III) acetylacetonate (Mn(acac)₃), manganese(II) chloride (MnCl₂), manganese(II) sulfate (MnSO₄) and manganese(II) nitrate (Mn(NO₃)₂) is dissolved in an adequate volume of water. The amount of the copper salt is equal to the amount of copper preferred in the zeolite. The incipient wetness impregnation is carried out at room temperature. Afterwards, the manganese-exchanged zeolite is dried at temperatures between 60 and 150° C. for 8 to 16 hours, and the mixture is subsequently heated to temperatures in the range of 500 to 900° C.

Solid State Ion Exchange

Suitable manganese salts are, for instance, manganese(II) acetate (Mn(CH₃COO)₂), manganese(II) acetylacetonate (Mn(acac)₂), manganese(III) acetylacetonate (Mn(acac)₃), manganese(II) chloride (MnCl₂), manganese(II) sulfate (MnSO₄) and manganese(II) nitrate (Mn(NO₃)₂). The copper salt and the zeolite are mixed in a dry state, and the mixture is subsequently heated to temperatures in the range of 250 to 900° C. A process for producing metal-comprising zeolites is, for instance, disclosed in US 2013/0251611 A1. This process may be applied to the zeolites of the present invention without departing from the scope of the claims.

The methods for introducing or removing cations which are exemplarily described above for exchanging manganese and ammonium ions can be applied for the exchange of alkali metal cations and cations of metal P other than manganese as well. It is well known that the introduction of different metal ions, e.g. of manganese ions and cations of another metal P, can be carried out sequentially or by co-ion exchange. A sequential ion exchange means that the different cations are introduced one after the other, for example by introducing manganese in the first step and a metal P other than manganese in the second step. A co-ion exchange means that all cations, for example manganese and calcium, are exchanged together in one step. Sequential and co-ion exchange can also be applied if more than two different cations shall be exchanged, for example cations of manganese, calcium and a rare earth metal. The skilled person knows how to apply the ion exchange methods, which are exemplarily described above for the exchange of manganese and ammonium ions, to the exchange of other ions, and he can apply this knowledge to the present invention without departing from the scope of the claims.

Suitable magnesium salts for introducing magnesium via ion exchange are, for example, magnesium chloride (MgCl₂), magnesium nitrate (Mg(NO₃)₂), magnesium sulfate (MgSO₄), magnesium acetate (Mg(CH₃COO)₂) and magnesium acetylacetonate (Mg(acac)₂).

Suitable calcium salts for introducing calcium via ion exchange are, for example, calcium chloride (CaCl₂), calcium nitrate (Ca(NO₃)₂), calcium acetate (Ca(CH₃COO)₂) and calcium acetylacetonate (Ca(acac)₂).

Suitable barium salts for introducing barium via ion exchange are, for example, barium chloride (BaCl₂), barium nitrate (Ba(NO₃)₂), barium acetate (Ba(CH₃COO)₂) and barium acetylacetonate (Ba(acac)₂).

Suitable strontium salts for introducing strontium via ion exchange are, for example, strontium chloride (SrCl₂), strontium nitrate (Sr(NO₃)₂), strontium acetate (Sr(CH₃COO)₂) and strontium acetylacetonate (Sr(acac)₂).

Suitable yttrium salts for introducing yttrium via ion exchange are, for example, yttrium chloride (YCl₃), yttrium nitrate (Y(NO₃)₃), yttrium sulfate (Y₂(SO₄)₃), yttrium acetate (Y(CH₃COO)₃) and yttrium acetylacetonate (Y(acac)₃).

Suitable titanium salts for introducing titanium via ion exchange are, for example, tetrabutyl orthotitanate (Ti(O(CH₂)₃(CH₃))₄), titanium oxide acetylacetonate (TiO(acac)₂), titanyl sulfate (TiOSO₄), and ammonium hexafluortitanate ((NH₄)₂TiF₆).

Suitable zirconium salts for introducing zirconium via ion exchange are, for example, zirconium(II) chloride (ZrCl₂), zirconium(III) chloride (ZrCl₃), zirconium(IV) chloride (ZrCl₄), zirconium(II) nitrate (Zr(NO₃)₂), zirconium(IV) nitrate (Zr(NO₃)₄), zirconium(IV) sulfate (Zr(SO₄)₂), zirconium(IV) acetylacetonate (Zr(acac)₄), and zirconyl chloride (ZrOCl₂).

Suitable niobium salts for introducing niobium via ion exchange are, for example, niobium(IV) chloride (NbCl₄), niobium(V) chloride (Nb₂Cl₁₀), niobium oxalate (Nb(COO—COOH)₅) and niobium(V) oxychloride (NbOCl₃).

Suitable salts for introducing iron via ion exchange can be Fe²⁺ or Fe³⁺ salts such as iron(III) chloride (FeCl₃), iron(II) sulfate (FeSO₄), iron(III) sulfate (Fe₂(SO₄)₃), iron(III) nitrate (Fe(NO₃)₃), iron(II) acetate (Fe(CH₃COO)₂), iron(III) acetylacetonate (Fe(acac)₃), iron(II) gluconate (Fe(C₆H₁₁O₇)₂), and iron(II) fumarate (Fe(COO(CH)₂(COO)₂).

Suitable zinc salts for introducing zinc via ion exchange are, for example, zinc acetate (Zn(CH₃COO)₂), zinc acetylacetonate (Zn(acac)₂), zinc chloride (ZnCl₂), zinc nitrate (Zn(NO₃)₂) and zinc sulfate (ZnSO₄).

Suitable silver salts for introducing manganese via ion exchange are, for example, silver nitrate (AgNO₃), silver acetate (Ag(CH₃COO)), silver acetylacetonate (Ag(acac)), silver oxide (Ag₂O) and silver carbonate (Ag₂CO₃).

Suitable lanthanum salts for introducing lanthanum via ion exchange are, for example, lanthanum carbonate (La₂(CO₃)₃), lanthanum chloride (LaCl₃), lanthanum nitrate (La(NO₃)₃), lanthanum acetate (La(CH₃COO)₃) and lanthanum acetylacetonate (La(acac)₃).

Suitable cerium salts for introducing cerium via ion exchange are, for example, cerium(III) chloride (CeCl₃), cerium(III) sulfate (Ce₂SO₄)₃), cerium(IV) sulfate (Ce(SO₄)₂), cerium(III) nitrate (Ce(NO₃)₃), cerium(III) acetate (Ce(CH₃COO)₃) and cerium(III) acetylacetonate (Ce(acac)₃).

Suitable salts of praseodymium, neodymium, gadolinium, terbium, dysprosium, holmium, erbium, thulium, ytterbium and lutetium are the chlorides, sulfates, nitrates, acetates and acetylacetonates of the trivalent cations of Pr, Nd, Gd, Tb, Dy, Ho, Er, Tm, Yb and Lu.

Suitable promethium salts for introducing promethium via ion exchange are, for example, promethium(III) chloride (PmCl₃) and promethium(III) nitrate (Pm(NO₃)₃),

Suitable samarium salts for introducing samarium via ion exchange are, for example, samarium(III) chloride (SmCl₃), samarium(III) acetate (Sm(CH₃COO)₃, samarium(III) carbonate (Sm₂(CO₃)₃), samarium(III) nitrate (Sm(NO₃)₃)), samarium(III) oxide (Sm₂O₃), samarium(III) sulfate (Sm₂(SO₄)₃) and samarium(III) acetylacetonate (Sm(acac)₃).

Suitable europium salts for introducing europium via ion exchange are, for example, europium(II) chloride (EuCl₂), europium(III) chloride (EuCl₃), europium(III) nitrate (Eu(NO₃)₃), europium(III) acetate (Eu(CH₃COO)₃) and europium(III) acetylacetonate (Eu(acac)₃).

In certain cases, it may also be desirable to alter the chemical composition of the obtained molecular sieve, such as altering the silica-to-alumina molar ratio. Without being bound by any order of the post-synthetic treatments, acid leaching (inorganic and organic using complexing agents such as EDTA etc. can be used), steam-treatment, de-silication and combinations thereof or other methods of demetallation can be useful in this case.

In one embodiment of the present invention, the molar ratio A/Al₂O₃ of the as-made molecular sieve of the CHA-type is greater than 0 to about 2.0, and at least a part of the alkali metal A is removed from the molecular sieve of the CHA-type by ion-exchange with ammonium.

If a part or all of the alkali ions shall be removed and/or the chemical composition of the obtained molecular sieve shall be altered, such as altering the silica-to-alumina molar ratio, it is desirable to perform these reaction steps before the thermal treatment at temperatures of 150 to 750° C. as described above.

Crystalline molecular sieves are typically expensive starting materials, particularly if they have a high SAR. As was mentioned above, it is an advantage of the present invention that it is possible to use a cheap non-molecular sieve source of silicon and/or non-molecular sieve source of aluminum as a starting material in order to reduce the production costs. In an alternative embodiment, it is possible to use a less expensive molecular sieve such as a molecular sieve with a low SAR in combination with appropriate amounts of non-molecular sieve source of silicon and optionally non-molecular sieve source of aluminum as a starting material to provide a molecular sieve having a higher SAR as an end product. In this manner the SAR can be easily adapted in a cost-effective manner to the desired value.

The molar ratio of the transition metal Me and the OSDA1 is smaller than or equal to 1, preferably 0.4 to 0.8, and the molar ratio of transition metal Me and aluminium is smaller than 0.5, preferably 0.1 to 0.4. It has surprisingly been found that the copper amount of the zeolite obtainable by the method according to the present invention is significantly lower than the copper contents of zeolites according to methods of the prior art. In the prior art, many methods for the preparation of molecular sieves of the CHA-type are known which make use of Cu-TEPA. TEPA is used as the OSDA, and by complexing it with copper, the transition metal copper can also be introduced during the one-pot synthesis. However, in the methods known so far, the molar ratio of copper to aluminium is typically higher than 0.5, and copper and TEPA or TETA are used in stoichiometric ratios, which means that one mole of copper is used per one mole of TEPA or TETA. By contrast, the present invention uses the transition metal, which is selected from copper, iron, zinc and mixtures thereof, in an “understoichiometric amount”: a maximum of 0.5 moles of the transition metal is used per mole of aluminium and a maximum of 1 moles of the transition metal is used per mole of TEPA and/or TETA. This allows the formation of molecular sieves of the CHA-type with a lower transition metal content and saves the additional step of reducing the transition metal amount of the zeolite via ion exchange. Reducing the transition metal amount via ion exchange inevitably also reduces the amount of alkali metal A. Thus, the prior art does not provide a method of reducing or adjusting the amount of transition metal without affecting the amount of alkali metal which is present in the zeolite as well.

By contrast, the method of the present invention allows to adjust the amounts of first metals Me, second metals P and alkali metals independently from one another. Furthermore, the method according to the present invention allows to use the cheap OSDA tetraethylene pentaamine and also the use of cheap, non-molecular sieve sources of silicon and aluminum. Several methods known in the prior art make use of either very expensive OSDAs and/or expensive molecular sieves as the main sources or the only sources for silicon and aluminum, which makes the synthesis of molecular sieves of the CHA-type very expensive.

In addition to the components listed above, the synthesis mixture can also contain inexpensive pore-filling agents that can help in the preparation of more siliceous products. Such pore-filling agents could be crown-ethers and other uncharged molecules. The amounts are not particularly limited and can range from 0 to about 1, preferably 0 to about 0.5 based on silica (mol/mol).

The silica-alumina ratios (SAR) of the molecular sieve are not particularly limited, preferably the silica-alumina ratio is less than 25, more preferably 20 or less, and even more preferably from 5 to 12.

The molecular sieve which is obtained according to the method of the present invention is particularly useful in heterogeneous catalytic conversion reactions, such when the molecular sieve catalyzes the reaction of molecules in the gas phase or liquid phase. It can also be formulated for other commercially important non-catalytic applications such as separation of gases. The molecular sieve provided by the invention and from any of the preparation steps described above can be formed into a variety of physical shapes useful for specific applications. For example, the molecular sieve can be used in the powder form or shaped into pellets, extrudates or molded monolithic forms, e.g. as a full body corrugated substrate containing the molecular sieve or a honeycomb monolith. Furthermore, the molecular sieve can be present in the form of a coating on a carrier substrate, i.e. as a washcoat on a carrier substrate.

In shaping the molecular sieve, it will typically be useful to apply additional organic or inorganic components as matrix components. All inert materials which are otherwise used for the manufacturing of catalyst substrates may be used as matrix components in this context. It deals, for instance, with silicates, oxides, nitrides or carbides, with magnesium aluminum silicates being particularly preferred.

In one embodiment, the carrier substrates may be catalytically active on their own, and they may comprise catalytically active material, e.g. SCR-catalytically active material. SCR-catalytically active materials which are suitable for this purpose are basically all materials known to the skilled person, for example catalytically active materials based on mixed oxides, or catalytically active materials based on copper-exchanged, zeolitic compounds. Mixed oxides comprising compounds of vanadium, titanium and tungsten are particularly suitable for this purpose.

In one embodiment, catalytically active carrier materials are manufactured by mixing 10 to 95 wt.-% of at least one inert matrix component and 5 to 90 wt.-% of a catalytically active material, followed by extruding the mixture according to well-known protocols. As already described above, inert materials that are usually used for the manufacture of catalyst substrates may be used as the matrix components in this embodiment. Suitable inert matrix materials are, for example, silicates, oxides, nitrides and carbides, with magnesium aluminum silicates being particularly preferred. Catalytically active carrier materials obtainable by such processes are known as “extruded catalysed substrate monoliths”.

The application of the catalytically active catalyst onto either the inert carrier substrate or onto a carrier substrate which is catalytically active on its own as well as the application of a catalytically active coating onto a carrier substrate, said carrier substrate comprising a molecular sieve according to the present invention, can be carried out following manufacturing processes well known to the person skilled in the art, for instance by widely used dip coating, pump coating and suction coating, followed by subsequent thermal post-treatment (calcination).

The skilled person knows that in the case of wall-flow filters, their average pore sizes and the mean particle size of the catalysts may be adjusted to one another in a manner that the coating thus obtained is located onto the porous walls which form the channels of the wall-flow filter (on-wall coating). However, the average pore sizes and the mean particle sizes are preferably adjusted to one another in a manner that the catalyst is located within the porous walls which form the channels of the wall-flow filter. In this preferable embodiment, the inner surfaces of the pores are coated (in-wall coating). In this case, the mean particle size of the catalysts has to be sufficiently small to be able to penetrate the pores of the wall-flow filter.

The molecular sieve can also be employed coated onto or introduced into a substrate that improves contact area, diffusion, fluid and flow characteristics of the gas stream. The substrate can be a metal substrate, an extruded substrate or a corrugated substrate made of ceramic paper. The carrier substrates may consist of inert materials, such as silicon carbide, aluminum titanate, cordierite, metal or metal alloys. Such carrier substrates are well-known to the skilled person and available on the market. The substrate can be designed as a flow-through or a wall-flow design. In the latter case the gas flows through the walls of the substrate, and in this way, it can also contribute with an additional filtering effect.

The molecular sieve is typically present on or in the substrate in amounts from about 10 to about 600 g/L, preferably about 100 to about 300 g/L, as calculated by the weight of the molecular sieve per volume of the total catalyst article.

The molecular sieve can be coated on or into the substrate using known wash-coating techniques. In this approach the molecular sieve powder is suspended in a liquid medium together with binder(s) and stabilizer(s). The wash coat can then be applied onto the surfaces and walls of the substrate. The wash coat optionally also contains binders based on TiO₂, SiO₂, Al₂O₃, ZrO₂, CeO₂ and combinations thereof.

The molecular sieve can also be applied as one or more layers on the substrate in combination with other catalytic functionalities or other molecular sieve catalysts. One specific combination is a layer with an oxidation catalyst containing, for example, platinum or palladium or combinations thereof. The molecular sieve can be additionally applied in limited zones along the gas-flow-direction of the substrate.

The molecular sieves prepared according to the present invention may advantageously be used for the exhaust purification of lean combustion engines, in particular for diesel engines. They convert nitrogen oxides comprised in the exhaust gas into the harmless compounds nitrogen and water.

The molecular sieve prepared according to the invention can be used in the catalytic conversion of nitrogen oxides, typically in the presence of oxygen. In particular, the molecular sieve can be used in the selective catalytic reduction (SCR) of nitrogen oxides with a reductant such as ammonia and precursors thereof, including urea, or hydrocarbons. For this type of application, the molecular sieve will typically be loaded with a transition metal such as copper or iron or combinations thereof, using any of the procedures described above, in an amount sufficient to catalyze the specific reaction.

Commonly known exhaust gas purification systems for diesel engines are often formed by arranging an oxidation catalyst (DOC) having an oxidative function for carbon monoxide and hydrocarbons and optionally nitrogen monoxide and aforementioned selective catalytic reduction type catalyst (SCR), in a flow path of exhaust gas, characterized in that a spraying means to supply an urea aqueous solution or an aqueous ammonia solution or gaseous ammonia is arranged downstream of the aforementioned oxidation catalyst and upstream of aforementioned selective catalytic reduction type catalyst. The skilled person knows that the DOC catalyst might also be replaced by a passive NOx adsorber catalyst (PNA) or NOₓ storage catalyst (NSC) which is able to store NOx from the exhaust gas at lower temperatures and to desorb the NOₓ thermally at higher temperatures (PNA) or reduce the NOx directly by means of a reductant like rich exhaust gas (Lambda<1) or other reducing agents like fuel (NSC), respectively. The PNA or NSC catalysts preferably also contain catalytic functions for the oxidation of carbon monoxide and hydrocarbons as well as optionally the oxidation of nitrogen monoxide. Furthermore, a diesel particulate filter (DPF) for filtering out soot is often arranged in the system together with the DOC (or NSC) catalyst and the SCR catalyst. In these arrangements, combustible particle components are deposited on the DPF and combusted therein. Such arrangements are, for instance, disclosed in EP 1 992 409 A1. Widely used arrangements of such catalysts are, for example (from upstream to downstream):

DOC+(NH₃)+SCR (1)

DOC+DPF+(NH₃)+SCR (2)

DOC+(NH₃)+SCR+DPF (3)

DOC+(NH₃)+SCR+DOC+DPF (4)

DOC+(NH₃)+SDPF+(NH₃ opt.)+SCR (5)

DOC+CDPF+(NH₃)+SCR (6)

(NH₃)+SCR+DOC+CDPF(NH₃ opt.)+SCR (7)

(NH₃)+SCR+DOC+SDPF+(NH₃ opt.)+SCR (8)

(NH₃)+SCR+ASC (9)

DOC+(NH₃)+SCR+SDPF+(NH₃ opt.)+SCR (10)

DOC+(NH₃)+SDPF+SCR+(NH₃ opt.)+SCR (11)
(SDPF: Diesel particulate filter (DPF) coated with an SCR catalyst
CDPF: Catalysed Diesel particulate filter=DPF coated with a DOC)

In the above examples (1) to (11), (NH₃) represents a position where an urea aqueous solution, an aqueous ammonia solution, ammonium carbamate, ammonium formiate or another reducing agent reducing NOₓ via the SCR reaction selectively is supplied as a reducing agent by spraying. The supply of such urea or ammonia compounds in automotive exhaust gas purification systems is well known in the art. (NH₃ opt.) in examples 35 5, 7, 8, 10 and 11 means that said second source of urea or ammonia compounds is optional. The catalysts containing the molecular sieve according to the present invention are preferably positioned close to the engine or close to the DPF, since here the temperatures are highest in the system. Preferably the molecular sieves of the present invention are used on the SDPF or catalysts closely positioned to the filter like in system 10 and 11 where one SCR catalyst is located directly upstream or downstream the SDPF, respectively without additional NH₃ dosing in-between these two catalysts. Also the first SCR catalyst of systems 7 to 9 which is close coupled to the engine is a preferred embodiment of the present invention.

Hence, the present invention furthermore refers to a method for the purification of exhaust gases of lean combustion engines, characterized in that the exhaust gas is passed over a catalyst according to the present invention. Lean combustion engines are diesel engines, which are generally operated under oxygen rich combustion conditions, but also gasoline engines which are partly operated under lean (i.e. oxygen rich atmosphere with Lambda>1) combustion conditions. Such gasoline engines are, for instance, lean GDI engines or gasoline engines which are using the lean operation only in certain operation points of the engine like cold start or during fuel cut events. Due to the high thermal stability of the molecular sieves according to the present invention these molecular sieves might also be used in exhaust systems of gasoline engines. In this case a PNA, SCR or ASC catalyst might be arranged in combination with aftertreatment components typically used to clean exhaust emissions from gasoline engines like three way catalysts (TWC) or gasoline particulate filters (GPF). In these cases, the above mentioned system lay outs 1 to 11 are modified by replacing the DOC catalyst by a TWC catalyst and the DPF or CDPF by a GPF. In all those systems the dosing of ammonia is optional since gasoline engines are able to produce ammonia in situ during operation over the TWC catalyst so that the injection of aqueous urea or ammonia or another ammonia precursor upstream of the SCR catalyst might not be needed. In case a PNA is used in those systems, the PNA will preferably be located as a first catalyst in the system close to the engine to have an early heat up. The PNA might also be located in an under-floor position to prevent thermal damage of the catalyst. In these positions the exhaust temperatures can be controlled in order to not exceed 900° C.

In a preferred embodiment, ammonia is used as the reducing agent. The ammonia required may, for instance, be formed within the exhaust purification system upstream to a particulate filter by means of an upstream nitrogen oxide storage catalyst (“lean NOₓ trap”— LNT). This method is known as “passive SCR”.

Alternatively, ammonia may be supplied in an appropriate form, for instance in the form of urea, ammonium carbamate or ammonium formiate, and added to the exhaust gas stream as needed. A widespread method is to carry along an aqueous urea solution and to and to dose it into the catalyst according to the present invention via an upstream injector as required.

The present invention thus also refers to a system for the purification of exhaust gases emitted from lean combustion engines, characterized in that it comprises a catalyst comprising the molecular sieve according to the present invention, preferably in the form of a coating on a carrier substrate or as a component of a carrier substrate, and an injector for aqueous urea solutions.

For example, it is known from SAE-2001-01-3625 that the SCR reaction with ammonia proceeds more rapidly if the nitrogen oxides are present in a 1:1 mixture of nitrogen monoxide and nitrogen dioxide, or if the ratios of both nitrogen oxides are close to 1:1. As the exhaust gas from lean combustion engines generally contains an excess of nitrogen monoxide over nitrogen dioxide, this SAE paper suggests to increase the amount of nitrogen dioxide by means of an oxidation catalyst. The exhaust gas purification process according to the present invention may not only be applied in the standard SCR reaction, i.e. in the absence of nitrogen oxide, but also in the rapid SCR reaction, i.e. when part of the nitrogen monoxide has been oxidized to nitrogen dioxide, thus ideally providing a 1:1 mixture of nitrogen monoxide and nitrogen dioxide.

The present invention therefore also relates to a system for the purification of exhaust gases from lean combustion engines, characterized in that it comprises an oxidation catalyst, an injector for aqueous urea solutions and a catalyst comprising the molecular sieve according to the present invention, preferably in the form of a coating on a carrier substrate or as a component of a carrier substrate.

In a preferred embodiment of the exhaust gas purification system according to the present invention, platinum supported on a carrier support material is used as an oxidation catalyst.

Any carrier material for platinum and/or palladium which is known to the skilled person as suitable material may be used without departing from the scope of the claims. For example, these materials show a BET surface area of about 30 to about 250 m²/g, preferably about 50 to about 200 m²/g (measured according to DIN 66132). Preferred carrier substrate materials are alumina, silica, magnesium dioxide, titania, zirconia, ceria and mixtures and mixed oxides comprising at least two of these oxides. Particularly preferred materials are alumina and alumina/silica mixed oxides. If alumina is used, it is preferably stabilized, for instance with lanthanum oxide.

The exhaust gas purification system is arranged in an order wherein, in flow direction of the exhaust gas purification system, an oxidation catalyst is arranged first, followed by an injector for an aqueous urea solution, and finally a catalyst comprising the molecular sieve according to the present invention.

The skilled person knows that the exhaust gas purification system may comprise additional catalysts. A particulate filter may, for instance, be coupled with either the DOC, thus forming a CDPF, or with an SCR, thus forming an SDPF.

In one embodiment of the present invention, the exhaust gas purification system comprises a particulate filter coated with an SCR catalyst, wherein the SCR catalytically active material is a molecular sieve according to the present invention.

The molecular sieve according to the present invention can be coated into the walls of the filter (wall flow substrate) or on the surface of the filter walls. Also a combination of in-wall-coating and on-wall-coating is possible. The wall flow filter can be coated over the whole length of the filter or only partly from the inlet or from the outlet with the molecular sieve according to the present invention. Methods to apply a molecular sieve on such a filter are disclosed in WO 2017/178576 A1, WO 2018/029330 A1 and WO 2018/054928 A1. These methods are incorporated by reference.

Furthermore, the exhaust gas purification system may comprise a PNA. The PNA is a NOₓ storage device that adsorbs NOₓ at low temperatures. Once the exhaust temperatures increases, the stored NOₓ is released and reduced to nitrogen over a downstream catalyst, i.e. an SCR catalyst using ammonia, usually in the form of an aqueous urea solution, or an active, barium-based NSC. An NSC is a NOₓ storage catalyst.

In some PNA type catalysts, a combination of precious metals and molecular sieves is used for NOₓ trapping. The precious metal is a platinum group metal selected from ruthenium, rhodium, palladium, osmium, iridium, platinum and mixtures thereof. Preferably, the precious metal is chosen from palladium, platinum and mixtures thereof, more preferably, the precious metal is palladium. The total amount of the platinum group metal or the mixture is present in a concentration of about 0.01 to about 10 wt.-%, preferably about 0.05 to about 5 wt.-%, even more preferably about 0.1 to about 3 wt.-%, calculated as the respective platinum group metal and based on the total weight of the molecular sieve. In a preferred embodiment, the platinum group metal is palladium, and it is present in a concentration of about 0.5 to about 5 wt.-%, calculated as Pd and based on the total weight of the molecular sieve. In such a PNAs, the NOₓ trapping efficiency is influenced by the nuclearity and the oxidation state of Pd. The dispersion and lower oxidation states of Pd facilitate NOₓ adsorption. The NOₓ release temperature is dependent on the molecular sieve structure and is higher for small pore molecular sieves and lowest for large pore molecular sieves.

In one embodiment of the present invention, the exhaust purification system comprises a PNA catalyst, wherein the PNA catalytically active material comprises a molecular sieve according to the present invention and at least one precious metal selected from palladium, platinum, and mixtures thereof.

The platinum group metals may be introduced into the PNA via ion exchange of suitable PGM precursor salts as described above or via incipient wetness impregnation treatment of the molecular sieve or via injection of a PGM salt solution into an aqueous washcoat slurry. The skilled person knows that suitable precious metal precursor salts are the nitrates, acetates, sulfates and amine type complexes of the respective precious metals. He can apply this knowledge without departing from the scope of the claims.

The exhaust gas purification system may furthermore comprise an ammonia oxidation catalyst (ASC). It is well known to the skilled person that an ASC is preferably located downstream of the SCR, because recognizable amounts of NH₃ leave the SCR due to the dynamic driving conditions. Therefore, the conversion of excess ammonia which leaves the SCR is mandatory, since ammonia is also an emission regulated gas. Oxidation of ammonia leads to the formation of NO as main product, which would consequently contribute negatively to the total conversion of NOₓ of the whole exhaust system. An ASC may thus be located downstream the SCR to mitigate the emission of additional NO. The ASC catalyst combines the key NH₃ oxidation function with an SCR function. Ammonia entering the ASC is partially oxidized to NO. The freshly oxidized NO and NH₃ inside the ASC, not yet oxidized, can consequently react to N₂ following the usual SCR reaction schemes. In doing so, the ASC is capable of eliminating the traces of ammonia by converting them in a parallel mechanism to N₂.

In one embodiment of the present invention, the exhaust purification system comprises an ASC catalyst, wherein the ASC catalytically active material comprises a molecular sieve according to the present invention and at least one platinum group metal selected from platinum, palladium and mixtures thereof.

Platinum group metals are used as oxidation catalysts in an ASC, and molecular sieves may be used for the SCR function. The precious metal is a platinum group metal selected from ruthenium, rhodium, palladium, osmium, iridium, platinum and mixtures thereof. Preferably, the precious metal is chosen from palladium, platinum, rhodium and mixtures thereof, more preferably, the precious metal is platinum. In a preferred embodiment, the platinum group metal is added in the form of a precursor salt to a washcoat slurry and applied to the carrier monolith. The platinum group metal is present in a concentration of about 0.01 to about 10 wt.-%, preferably about 0.05 to about 5 wt.-%, even more preferably about 0.1 to about 3 wt.-%, calculated as the respective platinum group metal and based on the total weight of the washcoat loading. In a preferred embodiment, the platinum group metal is platinum, and it is present in a concentration of about 0.1 to about 1 wt.-%, calculated as Pt and based on the total weight of washcoat loading.

The most commonly applied components for the oxidation of ammonia by oxygen are based on metals like Pt, Pd, Rh, Ir, and Ru, but transition metal oxides or a combination of metal oxides, for example, oxides of Ce, Ti, V, Cr, Mn, Fe, Co, Nb, Mo, Ta, or W can also be used for this purpose. When such materials are combined with metal-loaded form of the molecular sieve having SCR activity, an ammonia slip catalyst is obtained.

Ammonia slip catalysts based on the molecular sieve prepared according to the invention may also contain auxiliary materials, for example, and not limited to binders, support materials for the noble metal components, such as Al₂O₃, TiO₂, and SiO₂. Such combinations can have different forms, such as a mixture of the ammonia oxidation component with the SCR-active form of the molecular sieve prepared according to the invention, reactors or catalyst items in series (see for example U.S. Pat. No. 4,188,364).

In particular, the ammonia slip catalyst can be a washcoated layer of a mixture of the ammonia oxidation component with the SCR-active form of the molecular sieve on a monolith, or a multi-layered arrangement washcoated on a monolith, in which the different layers contain different amounts of the ammonia oxidation component, or of the SCR-active form of the molecular sieve, or of any combination of the ammonia oxidation component and the SCR-active form of the molecular sieve of the invention (cf. e.g., JP 3436567, EP 1 992 409).

In another configuration, the ammonia oxidation component or the SCR-active form of the molecular sieve or any combination of the ammonia oxidation component and the SCR-active form of the molecular sieve is present in the walls of a monolith. This configuration can further be combined with different combinations of washcoated layers.

Another configuration of the ASC catalyst is a catalyst article with an inlet end and an outlet end, in which the inlet end contains an ammonia oxidation component, or SCR-active form of the molecular sieve, or any combination of the ammonia oxidation component and SCR-active form of the molecular sieve that is different from the ammonia oxidation component, or SCR-active form of the molecular sieve, or any combination of the ammonia oxidation component and SCR-active form of the molecular sieve at the outlet end.

The molecular sieve prepared according to the invention is useful as catalyst in the reduction of nitrogen oxides in the exhaust gas from a gas turbine using ammonia as a reductant. In this application, the catalyst may be arranged directly downstream from the gas turbine. It may also be exposed to large temperature fluctuations during gas turbine start-up and shut-down procedures.

In certain applications, the molecular sieve catalyst is used in a gas turbine system with a single cycle operational mode without any heat recovery system down-stream of the turbine. When placed directly after the gas turbine the molecular sieve is able to withstand exhaust gas temperatures up to 650° C. with a gas composition containing water.

Further applications of the molecular sieve are in a gas turbine exhaust treatment system in combination with a heat recovery system such as a Heat Recovery System Generator (HRSG). In such a process design, the molecular sieve catalyst is arranged between the gas turbine and the HRSG. The molecular sieve can be also arranged in several locations inside the HRSG.

Still another application of the molecular sieve is the employment as a catalyst in combination with an oxidation catalyst for the abatement of hydrocarbons and carbon monoxide in exhaust gas.

The oxidation catalyst, typically containing platinum group metals, such as Pt and Pd, can e.g. be arranged either up-stream or down-stream of the molecular sieve and both inside and outside of the HRSG. The oxidation functionality can also be combined with the molecular sieve catalyst into a single catalytic unit.

The oxidation functionality may be combined directly with the molecular sieve by using the molecular sieve as a support for the platinum group metals. The platinum group metals can also be supported onto another support material and physically mixed with the molecular sieve.

The molecular sieve is capable of removing nitrous oxide. It can for example be arranged in combination with a nitric acid production loop in a primary, secondary or a tertiary abatement setup. In such an abatement process, the molecular sieve can be used to remove nitrous oxide as well as nitrogen oxides as separate catalytic articles or combined into a single catalytic article. The nitrogen oxide may be used to facilitate the removal of the nitrous oxide. Ammonia or lower hydrocarbons, including methane, may also be added as a reductant to further reduce nitrogen oxides and/or nitrous oxide.

The molecular sieve can also be used in the conversion of oxygenates into various hydrocarbons. The feedstock of oxygenates is typically lower alcohols and ethers containing one to four carbon atoms and/or combinations thereof. The oxygenates can also be carbonyl compounds such as aldehyde, ketones and carboxylic acids. Particularly suitable oxygenate compounds are methanol, dimethyl ether, and mixtures thereof. Such oxygenates can be converted into hydrocarbons in presence of the molecular sieve. In such a process the oxygenate feedstock is typically diluted and the temperature and space velocity is controlled to obtain the desired product range.

A further use of the molecular sieve is as a catalyst in the production of lower olefins, in particular olefins suitable for use in gasoline or as a catalyst in the production of aromatic compounds.

In the above applications, the molecular sieve is typically used in its acidic form and will be extruded with binder materials or shaped into pellets together with suitable matrix and binder materials as described above.

Other suitable active compounds such as metals and metal ions may also be included to change the selectivity towards the desired product range.

The molecular sieve can further be used in the partial oxidation of methane to methanol or other oxygenated compounds such as dimethyl ether.

One example of a process for the direct conversion of methane into methanol at temperatures below 300° C. in the gas phase is provided in WO 2011/046621 A1. In such a process, the molecular sieve is loaded with an amount of copper sufficient to carry out the conversion. Typically, the molecular sieve will be treated in an oxidizing atmosphere where-after methane is subsequently passed over the activated molecular sieve to directly form methanol. Subsequently, methanol can be extracted by suitable methods and the active sites can be regenerated by another oxidative treatment.

Another example is disclosed in [K. Narsimhan, K. Iyoki, K. Dinh, Y. Roman-Leshkov, ACS Cent. Sci. 2016, 2, 424-429] where an increase or a continuous production of methanol is achieved by addition of water to the reactant stream to continuously extract methanol without having to alter the conditions between oxidative treatments and methanol formation.

The molecular sieve can be used to separate various gasses. Examples include the separation of carbon dioxide from natural gas and lower alcohols from higher alcohols. Typically, the practical application of the molecular sieve will be as part of a membrane for this type of separation.

The molecular sieve can further be used in isomerization, cracking hydrocracking and other reactions for upgrading oil.

The molecular sieve may also be used as a hydrocarbon trap e.g. from cold-start emissions from various engines.

Furthermore, the molecular sieve can be used for the preparation of small amines such as methylamine and dimethylamine by reaction of ammonia with methanol.

The present invention is illustrated by the following examples which should not be construed as limiting.

### BRIEF DESCRIPTION OF THE DRAWINGS

FIG. 1: XRD of the Cu-CHA before ion-exchange according to Example 1.

FIG. 2: XRD of the Cu-CHA before ion-exchange according to Example 2.

FIG. 3: XRD of the Cu-CHA according to Example 3.

FIG. 4: XRD of the Cu—Ce-La-CHA before ion-exchange according to Example 4.

FIG. 5: XRD of the Cu—Mn-CHA before ion-exchange according to Example 5.

FIG. 6: XRD of the Cu—Ce-CHA before ion-exchange according to Example 5.

FIG. 7: XRD of the Cu-CHA before ion exchange according to Comparative Example 1.

FIG. 8: XRD of the Cu-CHA before ion exchange according to Comparative Example 2.

FIG. 9: XRD of the Cu-CHA before ion exchange according to Comparative Example 3.

FIG. 10: XRD of the Cu-CHA before ion exchange according to Example 7.

FIG. 11: XRD of the Cu-CHA before ion exchange according to Example 9.

FIG. 12: XRD of the Cu—Mn-CHA before ion exchange according to Example 10.

FIG. 13: XRD of the Cu—Mn-CHA before ion exchange according to Example 12.

FIG. 14: XRD of the Cu—Mn-CHA before ion exchange according to Example 13.

FIG. 15: XRD of the Cu—Mn-CHA before ion exchange according to Example 14.

### EMBODIMENTS

### Example 1: Synthesis of Cu-CHA and Ion-Exchange

A 0.7M Cu/1M TEPA solution was made by adding 174.78 g of CuSO₄*5H₂O to 1000 mL distilled water. Afterwards 189.31 g TEPA was added under stirring. 10.35 g sodium hydroxide (VWR) was added to 126.93 ml of distilled water in a plastic beaker. To this solution, 506.54 g of sodium silicate and 242.19 g of the 0.7M Cu/1M TEPA solution was added. Afterwards 114.01 g CBV-100 (Zeolyst) was added slowly upon stirring. The final gel had the following molar ratios: 18 SiO₂/1 Al₂O₃/11.42 NaOH/0.7 Cu/1 TEPA/210 H₂O. The resulting mixture was homogenized by vigorous stirring for 30 minutes. This mixture was transferred to a 1 L autoclave and heated for 1.5 days at 145° C. under stirring with an anchor stirrer (140 RPM). The solid product was recovered by filtration and washing, and was dried at 60° C. for 16 h. The zeolite produced was a CHA framework type with a SAR (SiO₂/Al₂O₃) of 8.2, Cu/Al=0.33 and Na/Al=0.47.

The sample was suspended in a 1.39 M ammonium nitrate solution (10 mL solution/1 g of sample) and mixed for 4 hours at room temperature. The material was recovered by filtration and dried at 60° C. for 16 h. The sample was calcinated under oxygen at 550° C. for 8 h (heating rate: 1° C./min) and cooled down to 25° C. The product contained 0.28 Cu/Al and 0.07 Na/Al.

The XRD of Example 1 before ion-exchange is shown in FIG. 1.

### Example 2: Synthesis of Cu-CHA and Ion-Exchange

8.32 g sodium hydroxide (VWR) was added to 305.13 ml of distilled water in a plastic beaker. To this solution, 507.62 g of sodium silicate, 31.00 g CuSO₄*5H₂O and 33.67 g TEPA was added. Afterwards 114.25 g CBV-100 (Zeolyst) was added slowly upon stirring. The final gel had the following molar ratios: 18 SiO₂/1 Al₂O₃/11.14 NaOH/0.7 Cu/1 TEPA/210 H₂O. The resulting mixture was homogenized by vigorous stirring for 30 minutes. This mixture was transferred to a 1 L autoclave and heated for 4 days at 130° C. under stirring with an anchor stirrer (140 RPM). The solid product was recovered by filtration and washing, and was dried at 60° C. for 16 h. The zeolite produced is a CHA framework type with a SAR of 8.8, Cu/Al=0.33 and Na/Al=0.47.

The sample was suspended in a 1.39 M ammonium nitrate solution (10 mL solution/1 g of sample) and mixed for 4 hours at room temperature. The material was recovered by filtration and dried at 60° C. for 16 h. The sample was calcinated under oxygen at 550° C. for 8 h (heating rate: 1° C./min) and cooled down to 25° C. The product contained 0.28 Cu/Al and 0.07 Na/Al.

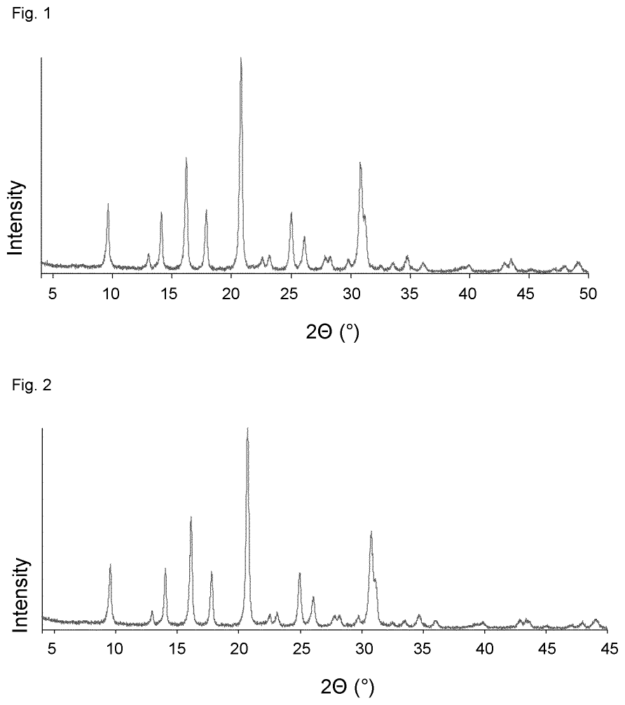

The XRD of Example 2 before ion-exchange is shown in FIG. 2.

### Example 3: Synthesis of Cu-CHA

A 0.5M Cu/1M TEPA solution was made by adding 124.78 g of CuSO₄*5H₂O to 1000 ml distilled water. Afterwards 189.31 g TEPA was added under stirring.

53.52 g sodium hydroxide (VWR) was added to 693.65 ml of distilled water in a plastic beaker. To this solution, 2554.96 g of sodium silicate and 1170.79 g of the 0.5 M Cu/1M TEPA solution was added. Afterwards 527.00 g CBV-100 (Zeolyst) was added slowly upon stirring. The final gel had the following molar ratios: 18 SiO₂/1 Al₂O₃/11.5 NaOH/0.5 Cu/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM). The solid product was recovered by filtration and washing, and was dried at 60° C. for 16 h. The product SAR was 8.5, and the product contained 0.25 Cu/Al and 0.70 Na/Al.

The sample was suspended in a 5 M ammonium nitrate solution (10 mL solution/1 g of sample) and mixed for 4 hours at RT. The material was recovered by filtration and dried at 60° C. for 16 h.

The sample was calcined under oxygen at 550° C. for 8 h (heating rate: 1° C./min) and cooled down to 25° C. The product contains 0.25 Cu/Al and 0.07 Na/Al.

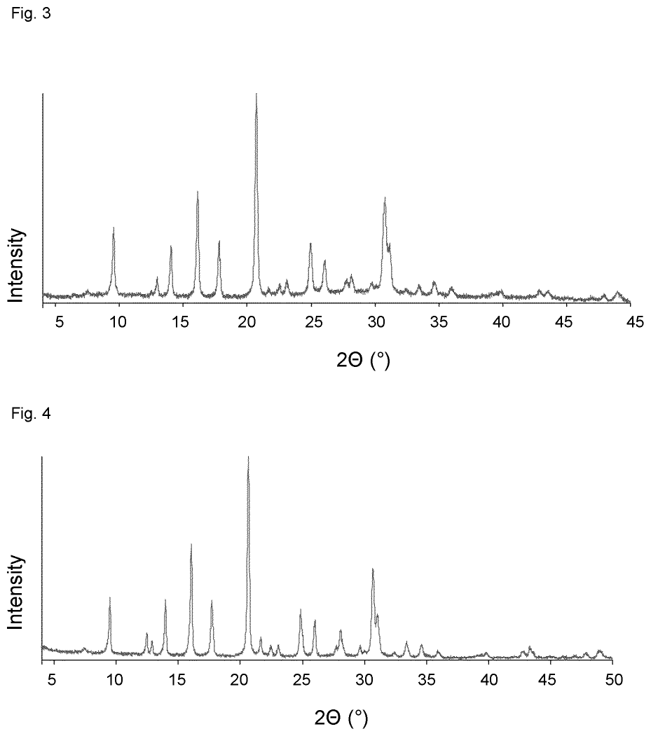

The XRD of Example 3 is shown in FIG. 3.

### Example 4: Synthesis of Cu—Ce-La-CHA and Ion-Exchange

A solution was made by adding 174.78 g of CuSO₄*5H₂O to 1000 ml distilled water. Afterwards 189.31 g TEPA was added under stirring. Afterwards 13.8 g of La(NO3)3·6H2O and 13.77 g of Ce(NO₃)₃*6H₂O was added under stirring. 17.79 g sodium hydroxide (VWR) was added to 124.88 ml of distilled water in a plastic beaker. To this solution, 500.75 g of sodium silicate and 243.90 g of the Cu—Ce-La-TEPA solution was added. Afterwards 112.71 g CBV-100 (Zeolyst) was added slowly upon stirring. The final gel had the following molar ratios: 18 SiO₂/1 Al₂O₃/12.5 NaOH/0.7 Cu/0.025 Ce/0.031 La/1 TEPA/210 H₂O. The resulting mixture was homogenized by vigorous stirring for 30 minutes. This mixture was transferred to a 1 L autoclave and heated for 1.5 days at 145° C. under stirring with an anchor stirrer (140 RPM). The solid product was recovered by filtration and washing, and was dried at 60° C. for 16 h. The zeolite produced has the CHA framework type. The product had a SiO₂/Al₂O₃ ratio of 7.7, and contained 0.32 Cu/Al, 0.02 Ce/Al and 0.012 La/Al.

The sample was suspended in a 5 M ammonium nitrate solution (10 ml solution/1 g of sample) and mixed for 4 hours at RT. The material was recovered by filtration and dried at 60° C. for 16 h. The sample was calcinated under oxygen at 550° C. for 8 h (heating rate: 1° C./min) and cooled down to 25° C. The final product contained 0.28 Cu/Al, 0.011 Ce/Al, 0.011 La/Al and 0.09 Na/Al.

The XRD of Example 4 before ion-exchange is shown in FIG. 4.

### Example 5: Synthesis of Cu—Mn-CHA and Ion-Exchange

A Cu-Mn-TEPA solution was made by adding 139.8264 g of CuSO₄*5H₂O to 1000 ml distilled water. Afterwards 189.31 g TEPA was added under stirring. Afterwards 75.28 g of Mn(NO₃)₂*4H₂O was added under stirring.

88.23 g sodium hydroxide (VWR) was added to 644.99 ml of distilled water in a plastic beaker. To this solution, 2483.82 g of sodium silicate and 1224.16 g of the Cu-Mn-TEPA solution was added. Afterwards 559.05 g CBV-100 (Zeolyst) was added slowly upon stirring. The final gel had the following molar ratios: 18 SiO₂/1 Al₂O₃/12.5 NaOH/0.56 Cu/0.3 Mn/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM).

The solid product was recovered by filtration and washing, and was dried at 60° C. for 16 h. The zeolite produced was a CHA framework type with a SAR of 8.52, and contained 0.28 Cu/Al, and 0.14 Mn/Al.

The sample was suspended in a 5M ammonium nitrate solution (10 ml solution/1 g of sample) and mixed for 4 hours at RT. The material was recovered by filtration and dried at 60° C. for 16 h. The sample was calcinated under oxygen at 550° C. for 8 h (heating rate: 1° C./min) and cooled down to 25° C. The final sample had a SAR of 8.44 and contained 0.28 Cu/Al, 0.13 Mn/Al and 0.12 Na/Al.

The XRD of Example 5 before ion-exchange is shown in FIG. 5.

### Example 6: Synthesis of Cu—Ce-CHA

A Cu—Ce-TEPA solution was made by adding 262.1745 g of CuSO₄*5H₂O to 1500 ml distilled water. Afterwards 283.965 g TEPA was added under stirring. Afterwards 130.2 g of Ce(NO₃)₃*6H₂O was added under stirring.

88.27 g sodium hydroxide (VWR) was added to 602.39 ml of distilled water in a plastic beaker. To this solution, 2484.78 g of sodium silicate and 1265.66 g of the Cu—Ce-TEPA solution was added. Afterwards 559.26 g CBV-100 (Zeolyst) was added slowly upon stirring. The final gel had the following molar ratios: 18 SiO₂/1 Al₂O₃/12.5 NaOH/0.7 Cu/0.2 Ce/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM). The solid product was recovered by filtration and washing, and was dried at 60° C. for 16 h. The zeolite produced was a CHA framework type with a SAR of 8.8, and contained 0.32 Cu/Al, and 0.09 Ce/Al and 0.68 Na/Al.

The sample was suspended in a 5M ammonium nitrate solution (10 ml solution/1 g of sample) and mixed for 4 hours at RT. The material was recovered by filtration and dried at 60° C. for 16 h. The sample was calcinated under oxygen at 550° C. for 8 h (heating rate: 1° C./min) and cooled down to 25° C. The final sample had a SAR of 8.8 and contained 0.29 Cu/Al, 0.09 Ce/Al and 0.11 Na/Al.

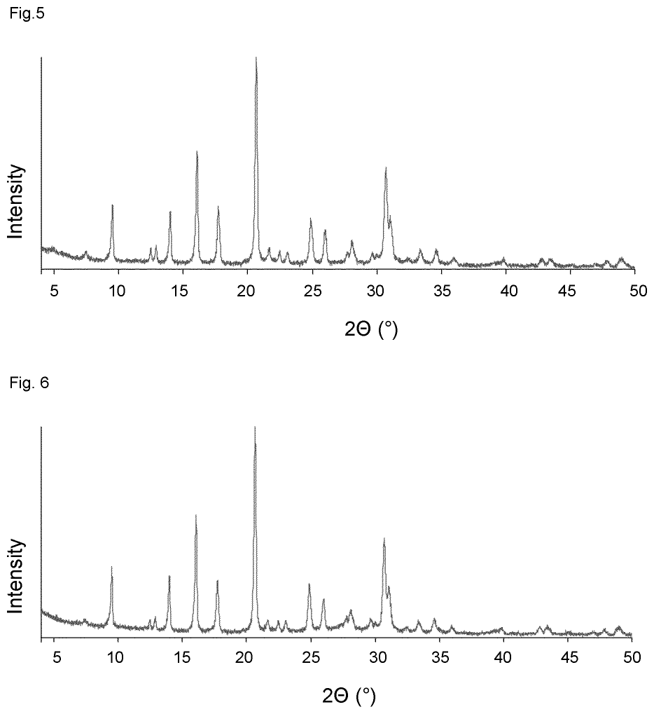

The XRD of Example 6 before ion-exchange is shown in FIG. 6.

### Comparative Example 1: Standard One-Pot Synthesis of Cu-CHA Followed by Ion Exchange

A 1M Cu-TEPA solution was made by adding 249.69 g of CuSO₄*5H₂O to 1000 ml distilled water. Afterwards 189.31 g TEPA was added under stirring.

71.33 g sodium hydroxide (VWR) was added to 604.49 ml of distilled water in a plastic beaker. To this solution, 2501.20 g of sodium silicate and 1260.02 g of the 1M Cu-TEPA solution was added. Afterwards 562.96 g CBV-100 (Zeolyst) was added slowly upon stirring. The final gel had the following molar ratios: 18 SiO₂/1 Al₂O₃/12 NaOH/1 Cu/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM). The solid product was recovered by filtration and washing, and was dried at 60° C. for 16 h. The zeolite produced was a CHA framework type with a SAR of 8.8. The product contained 0.47 Cu/Al and 0.45 Na/Al.

The sample was suspended in a 5M ammonium nitrate solution (10 ml solution/1 g of sample) and mixed for 4 hours at 80° C. The material was recovered by filtration and dried at 60° C. for 16 h, this procedure was repeated another 2 times. The sample was calcinated under oxygen at 550° C. for 8 h (heating rate: 1° C./min) and cooled down to 25° C.

Afterwards the zeolite was suspended in a 0.0375M ammonium nitrate solution (10 ml solution/1 g of sample) and mixed for 24 hours at room temperature. The material was recovered by filtration and dried at 60° C. for 16 h. The product contained 0.24 Cu/Al and 0.04 Na/Al

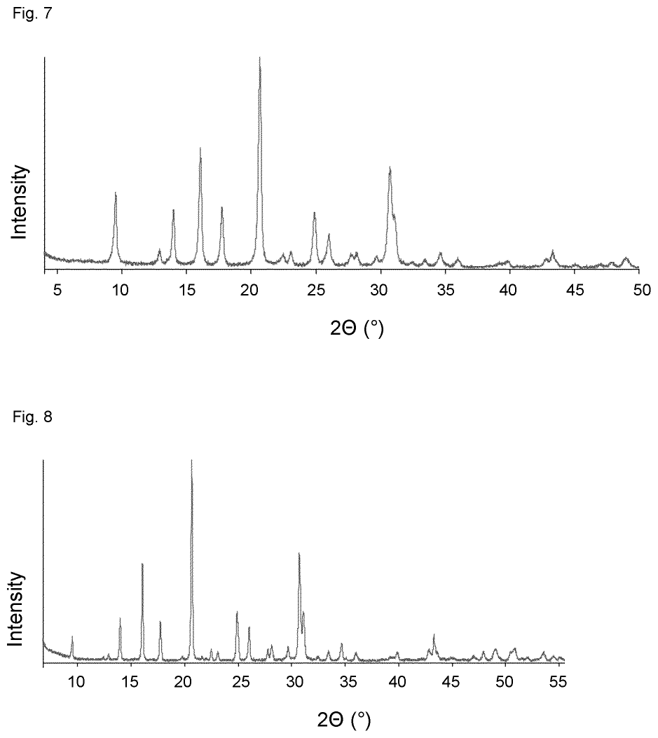

The XRD of Comparative Example 1 before ion exchange is shown in FIG. 7.

### Comparative Example 2: One-Pot Synthesis of Cu-CHA

A 1M Cu-TEPA solution was made by adding 249.69 g of CuSO₄*5H₂O to 1000 ml distilled water. Afterwards 189.31 g TEPA was added under stirring.

19.64 g sodium hydroxide (VWR) was added to 190.60 ml of distilled water in a plastic beaker. To this solution, 476.45 g of sodium silicate and 119.02 g of the 1M Cu-TEPA solution was added. Afterwards CBV-100 (Zeolyst) was added slowly upon stirring. The final gel had the following molar ratios: 31 SiO₂/1 Al₂O₃/23 NaOH/1.1 Cu/1.1 TEPA/400 H₂O. The resulting mixture was homogenized by vigorous stirring for 30 minutes. This mixture was transferred to a 1 L autoclave and aged for 1 days at 95° C. under stirring with an anchor stirrer (140 RPM). Afterwards the autoclave was heated to 135° C. and remained at this temperature for 1.5 days. The solid product was recovered by filtration and washing, and was dried at 60° C. for 16 h. The zeolite produced was a CHA framework type with a SAR of 9.1 and contained 0.53 Cu/Al.

The sample was suspended in a 1M ammonium nitrate solution (100 ml solution/1 g of sample) and mixed for 4 hours at 80° C. The material was recovered by filtration and dried at 60° C. for 16 h, this procedure was repeated 2 times. The sample was calcinated under oxygen at 550° C. for 8 h (heating rate: 1° C./min) and cooling down to 25° C. Afterwards the zeolite was suspended in a 0.0075M ammonium nitrate solution (100 ml solution/1 g of sample) and mixed for 24 hours at room temperature. The material was recovered by filtration and dried at 60° C. for 16 h. The product contains 0.28 Cu/Al.

The XRD of Comparative Example 2 before ion exchange is shown in FIG. 8.

### Comparative Example 3: One-Pot Synthesis of Cu-CHA

A 1M Cu-TEPA solution was made by adding 249.69 g of CuSO₄*5H₂O to 1000 ml distilled water. Afterwards 189.31 g TEPA was added under stirring.

100.12 g sodium hydroxide (VWR) was added to 852.03 ml of distilled water in a plastic beaker. To this solution, 2240.85 g of sodium silicate and 57.55 g of the 1M Cu-TEPA solution was added. Afterwards 249.46 g CBV-100 (Zeolyst) was added slowly upon stirring. The final gel had the following molar ratios: 31 SiO₂/1 Al₂O₃/23 NaOH/1 Cu/1 TEPA/400 H₂O. The resulting mixture was homogenized by vigorous stirring for 30 minutes. This mixture was transferred to a 5 L autoclave and was heated to 140° C. for days under stirring with an anchor stirrer (140 RPM). The solid product was recovered by filtration and washing, and was dried at 60° C. for 16 h. The zeolite produced was a CHA framework type with a SAR of 8.32 and contained 0.44 Cu/Al.

The sample was suspended in a 2M ammonium nitrate solution (20 ml solution/1 g of sample) and mixed for 4 hours at 80° C. The material was recovered by filtration and dried at 60° C. for 16 h. The sample was calcinated under oxygen at 550° C. for 8 h (heating rate: 1° C./min) and cooled down to 25° C. The product contained 0.35 Cu/Al.

A small amount the zeolite was suspended in a 0.075M ammonium nitrate solution (10 ml solution/1 g of sample) and mixed for 24 hours at room temperature. The material was recovered by filtration and dried at 60° C. for 16 h. The product contained 0.29 Cu/Al.

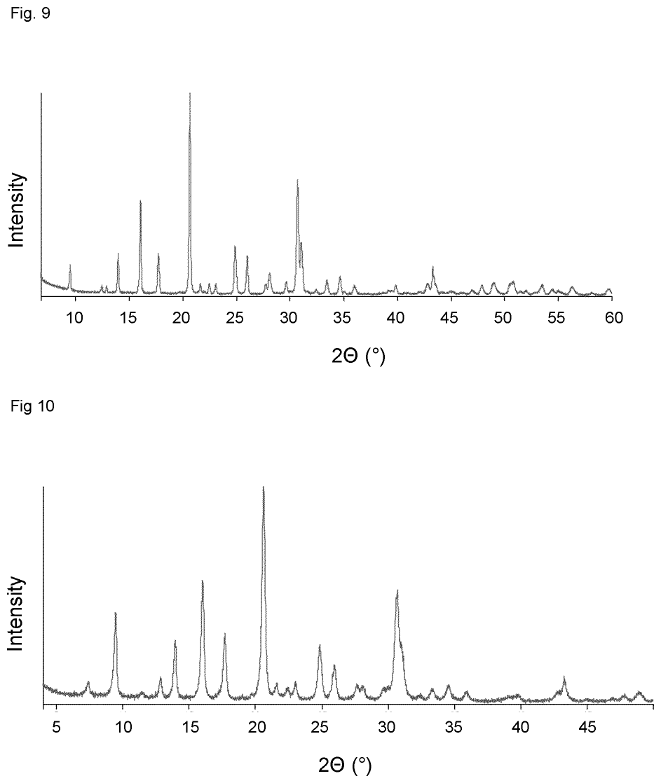

The XRD of Comparative Example 3 before ion exchange is shown in FIG. 9.

### Example 7: Synthesis of Cu-CHA

A first gel was made by adding 31.83 g sodium hydroxide (VWR) to 299.03 ml of distilled water in a plastic beaker. To this solution, 235.88 g of Ludox AS-40 and 102.10 g of the sodium aluminate solution was added. The first gel had the following molar ratios: 10 SiO₂/1 Al₂O₃/8.6 NaOH/180 H₂O. The resulting mixture was homogenized by vigorous stirring for 30 minutes. This mixture was transferred to a 1 L autoclave and heated for 14 hours at 95° C. under stirring with an anchor stirrer (140 RPM).

Next, a 2.1M/3M Cu-TEPA solution was made by adding 524.35 g of CuSO₄*5H₂O to 1000 ml distilled water. Afterwards 567.93 g TEPA was added under stirring.

Then, a second gel was made by adding 169.38 g of sodium silicate and 29.38 g of ZandoSil 30 (amorphous SiO₂) to 22.36 mL distilled water. To this solution, 109.90 g of the 2.1M-3M Cu-TEPA solution was added. The second gel was homogenized by vigorous stirring for 30 minutes. After the first gel was cooled to 40° C., the autoclave was opened and the 2nd gel was added to the 1 L autoclave. The final gel has the following molar ratios: 18 SiO₂/1 Al₂O₃/11.5 NaOH/0.7 Cu/1 TEPA/248 H₂O. The autoclave was heated for 1.5 days at 145° C. under stirring with an anchor stirrer (140 RPM). The solid product was recovered by filtration and washing, and was dried at 60° C. for 16 h. The zeolite produced had a CHA framework type with a SAR of 7.6, and contained 0.31 Cu/Al and 0.49 Na/Al.

The sample was suspended in a 5M ammonium nitrate solution (10 ml solution/1 g of sample) and mixed for 4 hours at RT. The material was recovered by filtration and dried at 60° C. for 16 h. The sample was calcinated under oxygen at 550° C. for 8 h (heating rate: 1° C./min) and cooling down to 25° C.

The final product contained 0.25 Cu/Al and 0.06 Na/Al.

The XRD of the Cu-CHA before ion exchange is shown in FIG. 10.

### Example 8: Synthesis of Cu-CHA

This Example was made in the same manner as Example 7 except for the ion exchange with ammonium nitrate: was suspended in a 1M ammonium nitrate solution (10 ml solution/1 g of sample) and mixed for 4 hours at RT. The material was recovered by filtration and dried at 60° C. for 16 h. The sample was calcinated under oxygen at 550° C. for 8 h (heating rate: 1° C./min) and cooling down to 25° C.

The final product contained 0.30 Cu/Al and 0.08 Na/Al.

### Example 9: Synthesis of Cu-CHA

A first gel was made by adding 52.71 g sodium hydroxide (VWR) to 358.90 ml of distilled water in a plastic beaker. To this solution, 25.02 g of Gibbsite was added and the solution was boiled overnight. afterwards 230.40 g of Ludox AS-40 was added. The first gel had the following molar ratios: 10 SiO₂/1 Al₂O₃/8.6 NaOH/180 H₂O. The resulting mixture was homogenized by vigorous stirring for 30 minutes. This mixture was transferred to a 1 L autoclave and heated for 14 hours at 95° C. under stirring with an anchor stirrer (140 RPM).

Next, a 1.5M/3M Cu-TEPA solution was made by adding 374.535 g of CuSO₄*5H₂O to 1000 ml distilled water. Afterwards 567.93 g TEPA was added under stirring.

Then, a second gel was made by adding 22.15 g of sodium hydroxide (VWR) to 20.97 mL distilled water. To this solution, 188.39 g of Ludox AS-40 was added. Afterwards 101.77 g of the 1.5M-3M Cu-TEPA solution was added. The second gel was homogenized by vigorous stirring for 30 minutes. After the first gel was cooled to 40° C., the autoclave was opened and the 2nd gel was added to the 1 L autoclave. The final gel has the following molar ratios: 18 SiO₂/1 Al₂O₃/12.1 NaOH/0.5 Cu/1 TEPA/248 H₂O. The autoclave was heated for 1.5 days at 142° C. under stirring with an anchor stirrer (140 RPM). The solid product was recovered by filtration and washing, and was dried at 60° C. for 16 h. The zeolite produced is a CHA framework type with a SAR of 7.6, and contains 0.23 Cu/Al and 0.53 Na/Al.

The XRD of the Cu-CHA before ion exchange is shown in FIG. 11.

### Example 10: Synthesis of Cu—Mn-CHA

A Cu-Mn-TEPA (0.5M Cu/0.3M Mn/1M TEPA) solution was made by adding 124.845 g of CuSO₄*5H₂O to 1000 ml distilled water. Afterwards 189.31 g TEPA was added under stirring. Afterwards 75.28 g of Mn(NO₃)₂*4H₂O was added under stirring.

88.39 g sodium hydroxide (VWR) was added to 653.61 ml of distilled water in a plastic beaker. To this solution, 2488.11 g of sodium silicate and 1209.64 g of the Cu-Mn-TEPA (0.5M Cu/0.3M Mn/1M TEPA) solution was added. Afterwards 560.01 g CBV-100 (Zeolyst) was added slowly upon stirring. The final gel has the following molar ratios: 18 SiO₂/1 Al₂O₃/12.5 NaOH/0.5 Cu/0.3 Mn/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM).

The solid product was recovered by filtration and washing, and was dried at 60° C. for 16 h. The zeolite produced is a CHA framework type with a SAR of 8.14, and contains 0.23 Cu/Al, 0.64 Na/Al and 0.15 Mn/Al.

The sample was suspended in a 5M ammonium nitrate solution (10 ml solution/1 g of sample) and mixed for 4 hours at RT. The material was recovered by filtration and dried at 60° C. for 16 h. The sample was calcinated under oxygen at 550° C. for 8 h (heating rate: 1° C./min) and cooled down to 25° C. The final sample has a SAR of 7.6 and contains 0.24 Cu/Al, 0.11 Na/Al and 0.14 Mn/Al.

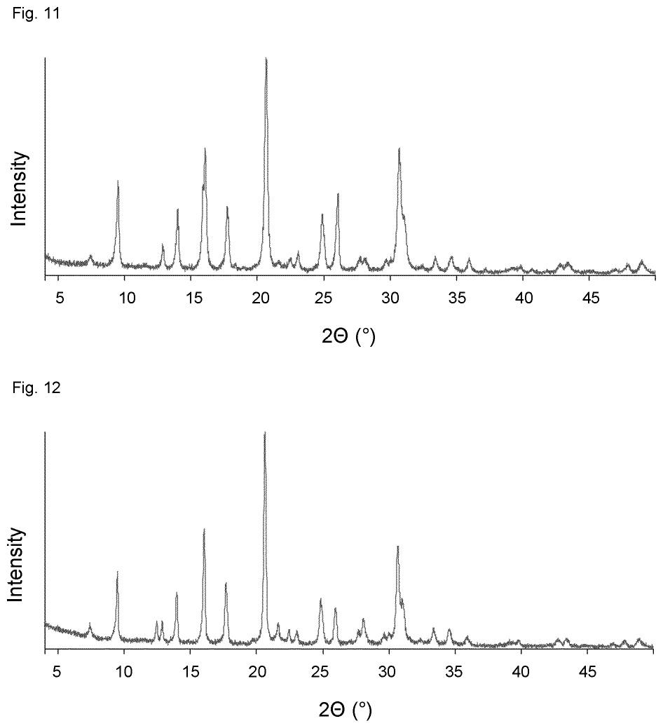

The XRD of the Cu—Mn-CHA before ion exchange is shown in FIG. 12.

### Example 11: Ion Exchange of Cu—Mn-CHA

The as made product of example 10 was suspended in a 5M ammonium nitrate solution (10 ml solution/1 g of sample) and mixed for 4 hours at RT. The material was recovered by filtration and dried at 60° C. for 16 h. This procedure was repeated a 2nd time. The sample was calcinated under oxygen at 550° C. for 8 h (heating rate: 1° C./min) and cooling down to 25° C. The final sample has a SAR of 7.6 and contains 0.23 Cu/Al, 0.06 Na/Al and 0.12 Mn/Al.

### Example 12: Synthesis of Cu—Mn-CHA

A 0.5M/1M Cu-TEPA solution was made by adding 124.78 g of CuSO₄*5H₂O to 1000 ml distilled water. Afterwards 189.31 g TEPA was added under stirring.

53.52 g sodium hydroxide (VWR) was added to 693.65 ml of distilled water in a plastic beaker. To this solution, 2554.96 g of sodium silicate and 1170.79 g of the 0.5M/1M Cu-TEPA solution was added. Afterwards 527.00 g CBV-100 (Zeolyst) was added slowly upon stirring. The final gel had the following molar ratios: 18 SiO₂/1 Al₂O₃/11.5 NaOH/0.5 Cu/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM). The solid product was recovered by filtration and washing, and was dried at 60° C. for 16 h. The zeolite produced is a CHA framework type with a SAR (SiO₂/Al₂O₃) of 8.5, Cu/Al=0.25 & Na/Al=0.70.

The sample was suspended in a 5 M ammonium nitrate solution (10 mL solution/1 g of sample) and mixed for 4 hours at RT. The material was recovered by filtration and dried at 60° C. for 16 h. This procedure was repeated a 2nd time 1.11 g Mn(NO₃)₂*4H₂O was added to 50 mL distilled water and afterwards 12.5 g of the sample was added (4 mL solution/1 g of sample) and mixed for 4 hours at 40° C. The material was recovered by filtration and dried at 60° C. for 16 h.

The sample was calcined under oxygen at 550° C. for 8 h (heating rate: 1° C./min) and cooled down to 25° C. The product contains 0.25 Cu/Al, 0.04 Na/Al and 0.04 Mn/Al.

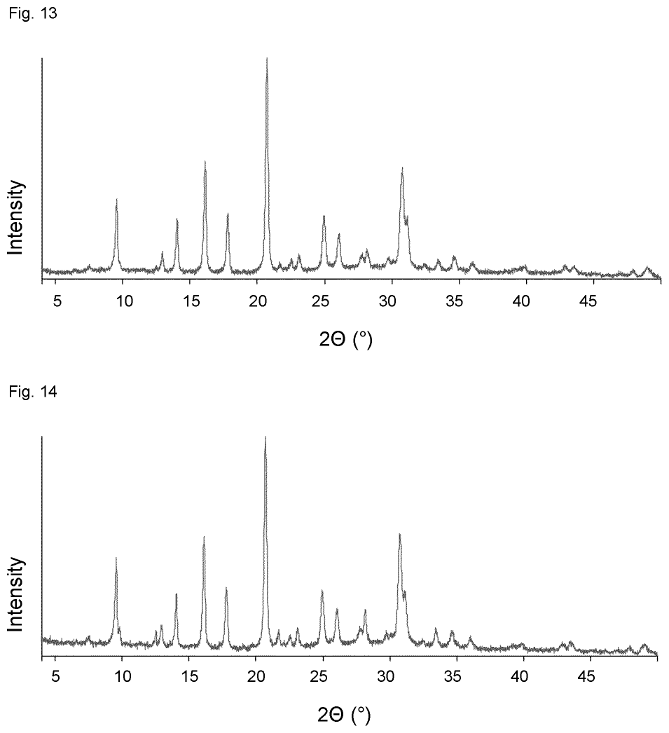

The XRD of the Cu—Mn-CHA before ion exchange is shown in FIG. 13.

### Example 13: Synthesis of Cu—Mn-CHA

A 0.5M/1M Cu-TEPA solution was made by adding 124.78 g of CuSO₄*5H₂O to 1000 ml distilled water. Afterwards 189.31 g TEPA was added under stirring.

53.67 g sodium hydroxide (VWR) was added to 702.02 ml of distilled water in a plastic beaker. To this solution, 2562.13 g of sodium silicate and 1153.82 g of the 0.5M/1M Cu-TEPA solution was added. Afterwards 526.50 g CBV-100 (Zeolyst) was added slowly upon stirring. The final gel has the following molar ratios: 18 SiO₂/1 Al₂O₃/11.5 NaOH/0.4 Cu/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM). The solid product was recovered by filtration and washing, and was dried at 60° C. for 16 h. The zeolite produced is a CHA framework type with a SAR (SiO₂/AlO₃) of 8.6, Cu/Al=0.20 and Na/Al=0.95.

13.70 g Mn(NO₃)₂*4H₂O was added to 500 mL distilled water and afterwards 122.77 g of the sample was added (4 mL solution/1 g of sample) and mixed for 4 hours at 40° C. The material was recovered by filtration and dried at 60° C. for 16 h.

The sample was suspended in a 1 M ammonium nitrate solution (10 mL solution/1 g of sample) and mixed for 4 hours at RT. The material was recovered by filtration and dried at 60° C. for 16 h

The sample was calcined under oxygen at 550° C. for 8 h (heating rate: 1° C./min) and cooled down to 25° C. The product contains 0.20 Cu/Al, 0.07 Na/Al and 0.13 Mn/Al.

The XRD of the Cu—Mn-CHA before ion exchange is shown in FIG. 14.

### Example 14: Synthesis of Cu—Mn-CHA

A 0.5M/1M Cu-TEPA solution was made by adding 124.78 g of CuSO₄*5H₂O to 1000 ml distilled water. Afterwards 189.31 g TEPA was added under stirring.

92.39 g sodium hydroxide (VWR) was added to 741.37 ml of distilled water in a plastic beaker. To this solution, 2443.13 g of sodium silicate and 1165.89 g of the 0.5M/1M Cu-TEPA solution was added. Afterwards 557.14 g of FAU (Si/Al=2.6) was added slowly upon stirring. The final gel has the following molar ratios: 18 SiO₂/1 Al₂O₃/12.1 NaOH/0.5 Cu/1 TEPA/210 H₂O. The resulting mixture was homogenized by vigorous stirring for 30 minutes. This mixture was transferred to a 5 L autoclave and heated for 1.5 days at 145° C. under stirring with an anchor stirrer (140 RPM). The solid product was recovered by filtration and washing, and was dried at 60° C. for 16 h. The zeolite produced is a CHA framework type with a SAR (SiO₂/Al₂O₃) of 8.0, Cu/Al=0.25 and Na/Al=0.75.

The sample was suspended in a 5 M ammonium nitrate solution (10 mL solution/1 g of sample) and mixed for 4 hours at RT. The material was recovered by filtration and dried at 60° C. for 16 h.

The sample was calcinated under oxygen at 550° C. for 8 h (heating rate: 1° C./min) and cooled down to 25° C. The product contains 0.25 Cu/Al and 0.09 Na/Al.

0.66 g of Mn(NO₃)₂*4H₂O was added to 50 mL distilled water and afterwards 12.19 g of the product was added (4 mL solution/1 g of sample) and mixed for 4 hours at 40° C. The material was recovered by filtration and dried at 60° C. for 16 h. The sample was calcined under oxygen at 550° C. for 2 h (heating rate: 1° C./min) and cooled down to 25° C. The product contains 0.20 Cu/Al, 0.06 Na/Al and 0.06 Mn/Al

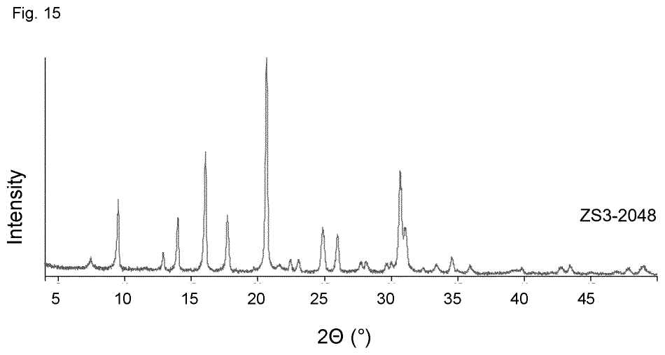

The XRD of the Cu—Mn-CHA before ion exchange is shown in FIG. 15.

As can be seen from the Examples according to the present invention and the Comparative Examples, the method for synthesizing chabazites according to the present invention provides CHA with a significantly lower ratio of transition metals Me to Al than methods according to the prior art. If the as-made chabazites according to the present invention are subsequently ion-exchanged with ammonium nitrate, the amounts of both the transition metals Me and the alkali metals A are reduced, but the content of the alkali metals A is reduced to a much greater extent than that of the transition metal Me. Further promoters P can be added with or without a reduction of the content of the transition metal Me.

### Example 15: SCR Performance Data

The SCR performance after hydrothermal aging was determined by heating zeolite catalyst pellets to 650° C. with a heating rate of 5° C./min, and keeping them under air flow with a humidity of 12 vol. % for 100 h. Prior to this experiment, the powder was pelletized to a particle size between 500 and 710 μm.

140 mg of catalyst pellets (500-710 μm) consisting of compressed zeolite powder are loaded in a quartz fixed bed tubular continuous flow reactor with on-line reaction product analysis. A typical gas composition for NH₃—SCR performance evaluation consists of 500 ppm NOₓ 750 ppm NH₃, 5% O₂ and 4% H₂O with a flow of 100 L*Th⁻¹. The catalyst first undergoes a pretreatment at 550° C., then the temperature is stepwise decreased from 550 to 150° C. with 50° C. intervals. An additional temperature plateau at 175° C. is foreseen. After reaching a stable temperature, an isothermal period of 5 minutes is foreseen for reaction product sampling at each temperature plateau.

NOₓ and N₂O at the various temperatures was determined by means of on-line FTIR (Fourier Transform Infra-Red) spectrometer. The results are shown in Table 1.

TABLE 1
NOx conversion and N2O formation after hydrothermal aging

| | 150° | 175° | 200° | 250° | 300° | 350° | 400° | 450° | 500° | 550° |
|---|---|---|---|---|---|---|---|---|---|---|
| | C. | C. | C. | C. | C. | C. | C. | C. | C. | C. |
| | NOₓ conversion (%) after 100 h650° C. | | | | | | | | | |
| Comparative | 12.6 | 38.9 | 73.7 | 97.3 | 99.4 | 99.3 | 98.6 | 97.7 | 96.5 | 93.9 |
| example 1 | | | | | | | | | | |
| Example 3 | 12.5 | 39.0 | 74.1 | 97.3 | 99.3 | 99.2 | 98.7 | 98.1 | 96.9 | 94.0 |
| Example 7 | 13.2 | 39.7 | 73.9 | 97.8 | 99.6 | 99.7 | 99.2 | 98.7 | 97.6 | 94.6 |
| Example 12 | 11.9 | 37.2 | 72.2 | 96.9 | 99.3 | 99.3 | 98.6 | 97.6 | 96.1 | 92.1 |
| Example 13 | 15.7 | 43.8 | 75.0 | 96.5 | 99.0 | 98.8 | 97.9 | 97.0 | 95.2 | 90.5 |
| Example 14 | 13.6 | 40.9 | 74.2 | 96.6 | 99.0 | 98.8 | 98.1 | 97.4 | 96.0 | 92.5 |
| | N₂O (ppm) after 100 h650° C. | | | | | | | | | |
| Comparative | 1.2 | 2.4 | 5.0 | 11.5 | 17.7 | 15.9 | 13.6 | 16.1 | 21.8 | 27.8 |
| example 1 | | | | | | | | | | |
| Example 3 | 1.2 | 2.2 | 4.4 | 10.1 | 15.6 | 14.4 | 12.8 | 15.2 | 20.4 | 25.8 |
| Example 7 | 1.2 | 2.3 | 4.7 | 10.7 | 15.9 | 14.8 | 13.0 | 15.0 | 20.1 | 25.3 |
| Example 12 | 1.2 | 2.2 | 4.3 | 9.3 | 14.4 | 12.9 | 10.9 | 12.6 | 17.4 | 22.3 |
| Example 13 | 1.2 | 2.1 | 3.8 | 8.3 | 11.6 | 9.8 | 9.0 | 11.1 | 14.8 | 18.7 |
| Example 14 | 1.1 | 1.8 | 3.2 | 7.0 | 11.0 | 9.6 | 8.4 | 10.0 | 13.9 | 17.8 |

1. A one-pot synthesis method for the preparation of a molecular sieve of the CHA-type with targeted contents of copper, iron, zinc, and mixtures thereof as well as targeted contents of alkali metals, the method comprising the steps of:
(I) providing the following components:
(a) a non-molecular sieve source of silicon and/or a non-molecular sieve source of aluminum;
(b) an alkali metal hydroxide AOH;
(c) water;
(d) a first organic structure-directing agent (OSDA1), which is tetraethylenepentamine (TEPA) and/or triethylenetetramine (TETA);
(e) cations of a first metal Me selected from copper, iron, zinc, and mixtures thereof;
(f) optionally a molecular sieve source of silicon and aluminum; and
(g) optionally seed crystals of faujasite FAU_{Seed}; and
(h) optionally at least one salt of one or more second metals P, wherein P is different from the first metal Me; and
(i) optionally a second organic structure-directing template (OSDA2);
(II) synthesizing and crystallizing a molecular sieve of the CHA-type, comprising the steps of
aa) mixing first portions of the components a), b) and c) according to step (I);
ab) optionally adding component g) according to step (I)
ac) crystallization of the mixture in a reactor;
ad) adding second portions of the components a), b) and c) and components d) and e) and optionally h) and/or i) to the mixture obtained in step ac);
ae) crystallization of the mixture obtained in step (II)(ad) in a reactor;
or
ba) mixing components a), b), c), d), e), f) and optionally h) and/or i) according to step (I);
bb) crystallization of the mixture obtained in step (II)(ba) in a reactor;
wherein the molar ratios of the components a), b) c), d), e), f) and optionally g), h) and/or i) of step (I) obtained after the completion of steps (II)(ad) and (II)(ba) are as follows:

| | |
|---|---|
| SiO₂/Al₂O₃ | about 10 to about 35 |
| SiO₂/AOH | about 1 to about 2 |
| SiO₂/H₂O | about 0.03 to about 0.2 |
| SiO₂/FAU_{Seed} | about 40 to 400 |
| OSDA1/SiO₂ | about 0.01 to about 0.1 |
| Me/Al | smaller than 0.5 |
| Me/OSDA1 | equal to or smaller than 1.0 |
| P/Me | 0 to 1, |
| OSDA2/OSDA1 | 0 to 0.1; |

and wherein in step (II)(aa)₃₀ to 75 mol-% of the non-molecular sieve source of silicon, 80 to 100 mol-% of the non-molecular sieve source of aluminum, 40 to 100 mol-% of the alkali metal hydroxide AOH and 30 to 90 mol-% of water are added,
and wherein in step (II)(ad)₇₀ to 25 mol-% of the non-molecular sieve source of silicon, 20 to 0 mol-% of the non-molecular sieve source of aluminum, 60 to 0 mol-% of the alkali metal hydroxide AOH and 70 to 10 mol-% of water are added, so that the mixture obtained after the completion of step (II)(ad) contains 100 mol % each of the non-molecular sieve source of silicon and aluminum, the alkali metal hydroxide AOH and water, and the molar ratios of the components a), b) c), d), e) and optionally g), h) and/or i) of step (I) obtained after the completion of step (II)(ad) are the ones given above; and
(III) separating the molecular sieve of the CHA-type.

2. The method of claim 1, wherein the non-molecular sieve source of silicon is selected from silica, fumed silica, silicic acid, silicates, colloidal silica, tetraalkyl orthosilicates, and mixtures thereof.

3. The method of claim 1, wherein the non-molecular sieve source of aluminum is selected from alumina, boehmite, aluminates, and mixtures thereof.

4. The method of claim 1, wherein the non-molecular sieve source of silicon and aluminum is selected from precipitated silica-alumina, amorphous silica-alumina, kaolin, amorphous mesoporous materials, and mixtures thereof.

5. The method according to claim 1, wherein the alkali metal hydroxide cations in the alkali metal hydroxide AOH are a mixture of sodium cations with potassium and/or ammonium cations.

6. The method according to claim 1, wherein the cation of the first metal Me is a copper cation.

7. The method according to claim 1, wherein the molecular sieve source of silicon and aluminum is selected from FAU, LTL, GME, LEV, AEI, LTA, OFF, CHA, ERI, and mixtures thereof.

8. The method according to claim 1, wherein the at least one salt of one or more second metals P is selected from salts of manganese, cesium, magnesium, calcium, strontium, barium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium, and mixtures thereof.

9. The method according to claim 1, wherein the at least one metal P is not introduced into the molecular sieve of the CHA type during the one-pot synthesis, but afterwards via liquid ion exchange, incipient wetness impregnation, or solid state ion exchange.

10. The method according to claim 1, wherein only an OSDA1 is provided, which is TEPA.

11. The method according to claim 1, wherein a part or all of the alkali ions and/or the part of the transition metal are removed from the molecular sieve after the separation of the molecular sieve of the CHA-type by ion-exchange.

12. The method of claim 1, comprising the further step of removing the OSDAs from the molecular sieve of the CHA-type by calcination, evaporation, decomposition, combustion, or a combination thereof.

13. A molecular sieve of the CHA-type which is made by the method according to claim 1.

14. A process for the removal of NOx from automotive combustion exhaust gases, which comprises using the molecular sieve of the CHA-type according to claim 13 as the SCR catalytically active material for the conversion of NOx.

15. A catalyzed substrate monolith comprising an SCR catalytically active material for the conversion of NOx for use in treating automotive combustion exhaust gases, wherein the SCR catalytically active material for the conversion of NOx is the molecular sieve of the CHA-type according to claim 13.

16. An exhaust gas purification system comprising a particulate filter coated with an SCR catalyst comprising the molecular sieve of the CHA-type according to claim 13.

17. An exhaust gas purification system comprising a PNA catalyst, wherein the PNA catalytically active material comprises the molecular sieve of the CHA-type according to claim 13 and at least one platinum group metal selected from ruthenium, rhodium, palladium, osmium, iridium, platinum, and mixtures thereof.

18. An exhaust gas purification system comprising an ASC catalyst, wherein the ASC catalytically active material comprises the molecular sieve of the CHA-type according to claim 13 and at least one platinum group metal selected from ruthenium, rhodium, palladium, osmium, iridium, platinum, and mixtures thereof.
